(19) United States
(12) Patent Application Publication
(10) Pub. No.: US 2024/0155239 A1
(43) Pub. Date: May 9, 2024

(54) INFORMATION PROCESSING SYSTEM, INFORMATION PROCESSING APPARATUS, INFORMATION PROCESSING METHOD, AND RECORDING MEDIUM

(71) Applicant: NEC Corporation, Minato-ku, Tokyo (JP)

(72) Inventors: Megumi HASHIMOTO, Tokyo (JP); Maya SAITO, Tokyo (JP); Kouhei OKINAKA, Tokyo (JP); Soichiro ARAKI, Tokyo (CN)

(73) Assignee: NEC Corporation, Minato-ku, Tokyo (JP)

(21) Appl. No.: 17/776,329

(22) PCT Filed: Sep. 30, 2021
(86) PCT No.: PCT/JP2021/036176

§ 371 Date: May 12, 2022

(51) Int. Cl. H04N 23/695; G01C 21/20; G06V 40/40; G08B 21/04; H04N 23/90

(52) U.S. Cl. CPC H04N 23/695; G01C 21/206; G06V 40/45; G08B 21/0476; H04N 23/90

(57) ABSTRACT

An information processing system (10) comprises: a rotation control unit (110) that makes a first camera (18) and a second camera (19) having a same rotation axis rotate on the rotation axis depending on a position of a target to be imaged; an acquisition unit (120) that acquires a first living body information from an image taken by the first camera and acquires a second living body information from an image taken by the second camera; an authentication unit (130) that executes authentication processing using the first living body information and the second living body information; and an execution unit (140) that executes, in a case that the authentication processing is successful, predetermined processing in a facility that the target uses. By such an information processing system, it is possible to execute authentication processing on the target with high accuracy and appropriately execute the predetermined processing.

### TECHNICAL FIELD

The disclosure relates to technical fields of an information processing system, an information processing apparatus, an information processing method, and a recording medium.

### BACKGROUND ART

As a system of this kind, there is known a system where authentication processing is carried out for a visitor to a dwelling house. For example, in Patent Document 1, it is disclosed that a biometric authentication (e.g. a facial authentication using a camera-equipped intercom) is performed for a visit staff of a housekeeping service at a timing of entering a house or at a timing of leaving a house.

### PRIOR ART DOCUMENT

### Patent Document

Patent Document 1: JP 2019-52476 A

### SUMMARY

### Technical Problem

This disclosure aims to improve the techniques disclosed in the prior art document.

### Solution to Problem

One aspect of an information processing system of this disclosure comprises a rotation control unit that makes a first camera and a second camera having a same rotation axis rotate on the rotation axis depending on a position of a target to be imaged; an acquisition unit that acquires a first living body information from an image taken by the first camera and acquires a second living body information from an image taken by the second camera; an authentication unit that executes authentication processing using the first living body information and the second living body information; and an execution unit that executes, in a case that the authentication processing is successful, predetermined processing in a facility that the target uses.

One aspect of an information processing apparatus of this disclosure is an information processing apparatus comprising: a rotation control unit that makes a first camera and a second camera having a same rotation axis rotate on the rotation axis depending on a position of a target to be imaged; an acquisition unit that acquires a first living body information from an image taken by the first camera and acquires a second living body information from an image taken by the second camera; an authentication unit that executes authentication processing using the first living body information and the second living body information; and an execution unit that executes, in a case that the authentication processing is successful, predetermined processing in a facility that the target uses.

One aspect of an information processing method of this disclosure is an information processing method executed by at least one computer, comprising: making first camera and a second camera having a same rotation axis rotate on the rotation axis depending on a position of a target to be imaged; acquiring a first living body information from an image taken by the first camera and acquiring a second living body information from an image taken by the second camera; executing authentication processing using the first living body information and the second living body information; and executing, in a case that the authentication processing is successful, predetermined processing in a facility that the target uses.

One aspect of a recording medium of this disclosure is a recording medium storing a computer program that allows at least one computer to execute an information processing method, the information processing method comprising: making first camera and a second camera having a same rotation axis rotate on the rotation axis depending on a position of a target to be imaged; acquiring a first living body information from an image taken by the first camera and acquiring a second living body information from an image taken by the second camera; executing authentication processing using the first living body information and the second living body information; and executing, in a case that the authentication processing is successful, predetermined processing in a facility that the target uses.

### BRIEF DESCRIPTION OF DRAWINGS

FIG. 1 A block diagram showing a hardware configuration of the information processing system according to the first example embodiment.

FIG. 2 A perspective view showing a configuration of an authentication terminal provided by the information processing system according to the first example embodiment.

FIG. 3 A perspective view showing a configuration of a camera periphery in the information processing system according to the first example embodiment.

FIG. 4 A block diagram showing a functional configuration of the information processing system according to the first example embodiment.

FIG. 5 A block diagram showing a functional configuration of a modification of the information processing system according to the first example embodiment.

FIG. 6 A flowchart showing a flow of operation by the information processing system according to the first example embodiment.

FIG. 7 A flowchart showing a flow of operation by the information processing system according to the second example embodiment.

FIG. 8 A block diagram showing a functional configuration of the information processing system according to the third example embodiment.

FIG. 9 A flowchart showing a flow of operation by the information processing system according to the fourth example embodiment.

FIG. 10 A flowchart showing a flow of operation by the information processing system according to the fifth example embodiment.

FIG. 11 A flowchart showing a flow of operation by the information processing system according to the sixth example embodiment.

FIG. 12 A block diagram showing a functional configuration of the information processing system according to the seventh example embodiment.

FIG. 13 A flowchart showing a flow of operation by the information processing system according to the seventh example embodiment.

FIG. 14 A flowchart showing a flow of operation by the information processing system according to the eighth example embodiment.

FIG. 15 A flowchart showing a flow of operation by the information processing system according to the ninth example embodiment.

FIG. 16 A flowchart showing a flow of operation by the information processing system according to the tenth example embodiment.

FIG. 17 A block diagram showing a functional configuration of the information processing system according to the eleventh example embodiment.

FIG. 18 A flowchart showing a flow of operation by the information processing system according to the eleventh example embodiment.

FIG. 19 A block diagram showing a functional configuration of the information processing system according to the twelfth example embodiment.

FIG. 20 A flowchart showing a flow of operation by the information processing system according to the thirteenth example embodiment.

FIG. 21 A flowchart showing a modification of the flow of the operation by the information processing system according to the thirteenth example embodiment.

FIG. 22 A plan view showing an example of a display screen for registering a target.

FIG. 23 A plan view showing an example of a display screen for updating registration information of the target.

FIG. 24 A plan view showing an example of a display screen indicating absence time of the registered target.

FIG. 25 A plan view showing an example of a display screen indicating in-home status of the registered target.

### DESCRIPTION OF EXAMPLE EMBODIMENTS

Hereinafter, an example embodiment of an information processing system, an information processing apparatus, an information processing method, and a recording medium will be described with reference to the drawings.

### First Example Embodiment

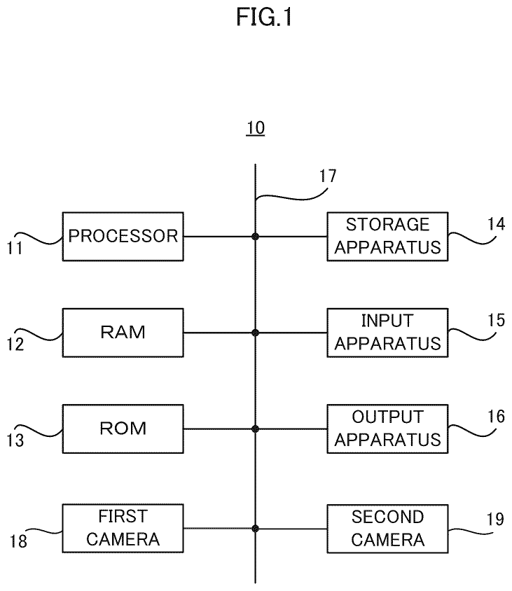

The information processing system according to a first example embodiment will be described with reference to FIGS. 1 to 6.

### (Hardware Configuration)

First, a hardware configuration of the information processing system according to the first example embodiment will be described with reference to FIG. 1. FIG. 1 is a block diagram showing the hardware configuration of the information processing system according to the first example embodiment.

As shown in FIG. 1, the information processing system 10 according to the first example embodiment comprises a processor 11, a RAM (Random Access Memory) 12, a ROM (Read Only Memory) 13, and a storage apparatus 14. The information processing system 10 may further comprise an input apparatus 15 and an output apparatus 16. The information processing system 10 may also comprise a first camera 18 and a second camera 19. The processor 11 described above, the RAM12, the ROM13, the storage apparatus 14, the input apparatus 15, the output apparatus 16, the first camera 18, and the second camera 19 are connected with each other via a data bus 17.

The Processor 11 reads a computer program. For example, the processor 11 is configured to read a computer program stored in at least one of the RAM12, the ROM13 and the storage apparatus 14. Alternatively, the processor 11 may read a computer program stored in a computer readable recording medium using a recording medium reading apparatus (not illustrated). The processor 11 may acquire (i.e. read) a computer program from an apparatus (not illustrated) located external to the information processing system 10 via a network interface. The processor 11 controls the RAM12, the storage apparatus 14, the input apparatus 15, and the output apparatus 16 by executing the computer program read. In particular, in the present example embodiment, when the computer program read by the processor 11 is executed, realized in the processor 11 are functional blocks for acquiring an image of a target to execute biometric authentication. That is, the processor 11 may function as a controller that executes each control of the information processing system 10.

The processor 11 may be configured as, for example, a CPU (Central Processing Unit), a GPU (Graphics Processing Unit), FPGA(field-programmable gate array), a DSP (Demand-Side Platform), and a ASIC(Application Specific Integrated Circuit. The processor 11 may be configured as one of these, or may be configured to use two or more of them in parallel.

The RAM12 temporarily stores the computer program which the processor 11 executes. The RAM12 temporarily stores data which the processor 11 temporarily uses when being executing a computer program. The RAM12 may be, for example, a D-RAM(Dynamic RAM).

The ROM13 stores the computer program to be executed by the processor 11. The ROM13 may further store fixed data. The ROM13 may be, for example, a P-ROM(Programmable ROM).

The storage apparatus 14 stores data that the information processing system 10 should preserve over a long period of time. The storage apparatus 14 may operate as a temporary storage apparatus of the processor 11. The storage apparatus 14 may include, for example, at least one of a hard disk apparatus, a magnet-optical disk apparatus, an SSD (Solid State Drive), and a disk array apparatus.

The input apparatus 15 is an apparatus that receives input instructions from a user of the information processing system 10. The input apparatus 15 may include, for example, at least one of a keyboard, a mouse, and a touch panel. The input apparatus 15 may be configured as a portable terminal, such as a smartphone or tablet.

The output apparatus 16 is an apparatus that outputs information relating to the information processing system 10 to the outside. For example, the output apparatus 16 may be a display apparatus (e.g. a display) capable of displaying information relating to the information processing system 10. Further, the output apparatus 16 may be a speaker or the like capable of audio output relating to the information processing system 10. The output apparatus 16 may be configured as a portable terminal, such as a smartphone or tablet.

The first camera 18 and the second camera 19 are each a camera installed in a position capable of taking an image of a target. The target here is not limited to a human, and may include an animal such as a dog or snake, a robot, and the like. The first camera 18 and the second camera 19 may each be configured as a camera which images a different part of the target from each other. For example, the first camera 18 may be configured to take an image including a face of the target, while the second camera 19 may be configured to take an image including an iris of the target. The first camera 18 and the second camera 19 may be each configured as a visible light camera, or a near-infrared camera. Further, the first camera 18 and the second camera 19 may be each configured as a depth camera, or a thermo-camera. The depth camera if capable of acquiring a depth image, for example, relating to a distance between the target and the camera. The thermos-camera is capable of acquiring, for example, a temperature image relating to a body temperature of the target. The different types of cameras described above (e.g. the visible light camera, the near infrared cameras, the depth camera, the thermos-camera) may be combined as appropriate to set to the first camera 18 and the second camera 19. The combination thereof is not particularly limited. For example, the first camera 18 is configured as a face camera, the second camera 19 may be the thermos-camera. the first camera 18 may be the depth camera and the second camera 19 may be the near-infrared camera. The first camera 18 and the second camera 19 may be each a camera which takes still images or a camera which takes moving images. The first camera 18 and the second camera 19 may be each a camera mounted on a device (e.g. a smartphone) of the target. The first camera 18 and the second camera 19 may each include a plurality of pieces. Further, more than one different camera from the first camera 18 and second camera 19 (e.g. a third camera and the fourth camera) may be provided. Specific configuration examples of the first camera 18 and second camera 19 will be described in detail later.

In FIG. 1, an example of the information processing system 10 configured to include a plurality of apparatuses has been exemplified, but all or part of their functions may be realized by one apparatus (the information processing apparatus). The information processing apparatus may be configured with, for example, only the processor 11, the RAM12, and the ROM13 described above. With respect to the other components (i.e. the storage apparatus 14, the input apparatus 15, the output apparatus 16, the first camera 18, and the second camera 19), an external apparatus connected to, for example, the information processing apparatus may comprise them. In addition, the information processing apparatus may realize a part of the arithmetic functions by an external apparatus (e.g. an external server, or a cloud system, etc.).

### (Configuration of Authentication Terminal)

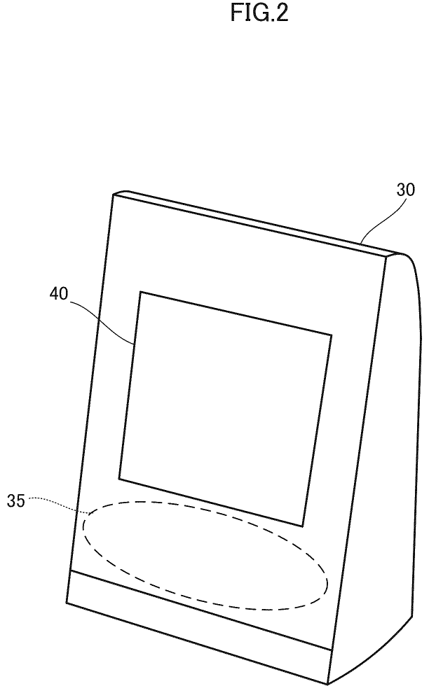

Next, a configuration of an authentication terminal provided in the information processing system 10 according to the first example embodiment will be described with reference to FIG. 2. FIG. 2 is a perspective view showing the configuration of the authentication terminal provided by the information processing system according to the first example embodiment.

As shown in FIG. 2, the information processing system 10 according to the first example embodiment is configured to comprise the authentication terminal 30 including the first camera 18 and the second camera 19 both having been described above. The housing of the authentication terminal 30 is constituted by, for example, a resin, metal, or the like. The front part of the authentication terminal 30 is provided with a display 40. This display 40 may display various information relating to the authentication terminal 30, messages to a user, and images or videos taken by the first camera 18 and the second camera 19. There is a camera installation portion 35 located in the lower portion of the display 40 (the portion surrounded by the broken line in the drawing). In the camera installation portion 35, the first camera 18 and the second camera 19 are installed. The first camera 18 and the second camera 19 may be installed so as to be visible from the outside of the housing, or may be installed so as not to be seen from the outside. For example, in a case that the first camera 18 and the second camera 19 are each configured as a visible light camera, the visible light camera, in order to take in external visible light, may be installed so as to be exposed to the outside (e.g. an opening portion may be provided in the vicinity of the visible light camera.) In a case that the first camera 18 and the second camera 19 are each configured as a near-infrared camera, the near-infrared camera may be installed so as not to be exposed to the outside (e.g. the camera may be covered with a visible light cut film or the like). Further, in a case that the first camera 18 is configured as a visible light camera and the second camera 19 is configured as a near-infrared camera, the first camera 18 may be installed so as to be exposed to the outside (e.g. by providing the opening portion in the vicinity of the first camera 18, etc.), and the second camera 19 may be installed so as not to be exposed to the outside (e.g. the camera may be covered with a visible light cut film or the like).

### (Configuration of Camera Periphery)

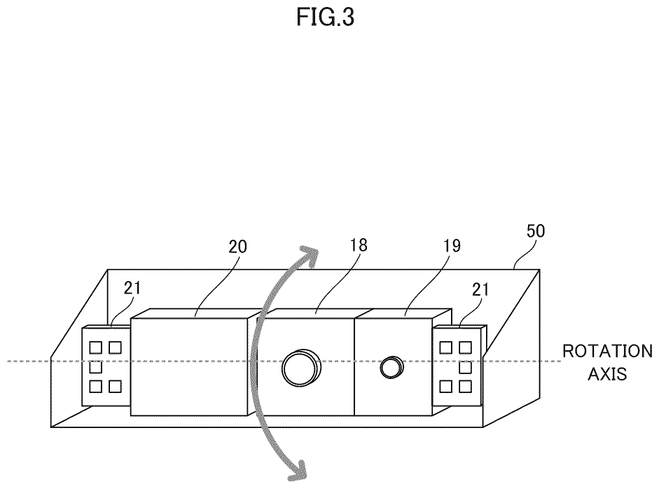

Next, a configuration of camera periphery in the information processing system 10 according to the first example embodiment (the internal configuration of the camera installation part 35 of the authentication terminal described above) will be specifically described with reference to FIG. 3. FIG. 3 is a perspective view showing the configuration of the camera periphery in the information processing system according to the first example embodiment. In the following, there will be described a case that the first camera 18 is a visible light camera for imaging the face of the target, and the second camera 19 is a near-infrared camera for imaging the iris of the target.

As shown in FIG. 3, the first camera 18 and the second camera 19 are disposed in a case 50. In the case 50, in addition to the first camera 18 and second camera 19, a motor 20 and two near-infrared illuminators 21 are disposed. The near-infrared illuminator 21 is configured so as to emit near-infrared light to the target when the second camera 19, which is the near-infrared camera, images the target.

In the present example embodiment, in particular, the first camera 18 and the second camera 19 are configured so as to be rotatable on the same rotation axis (see the broken line in the drawing). Specifically, the first camera 18 and the second camera 19 are configured so as to be driven by the motor 20 to be integrally rotated in the vertical direction around the rotation axis (see the arrow in the drawing). Therefore, when the first camera 18 and the second camera 19 are rotated upward, the imaging range of the first camera 18 and the second camera 19 will both change upward. Further, when the first camera 18 and the second camera 19 is rotated downward, the imaging range of the first camera 18 and the second camera 19 will both change downward.

Further, in the example shown in FIG. 3, the near-infrared illuminator 21 is also configured so as to rotate around the same rotation axis as the first camera 18 and second camera 19. Therefore, when the first camera 18 and the second camera 19 are rotated upward, the near-infrared illuminator 21 is also driven integrally upward. Further, when the first camera 18 and the second camera 19 is rotated downward, the near-infrared illuminator 21 is also driven integrally downward.

### (Functional Configuration)

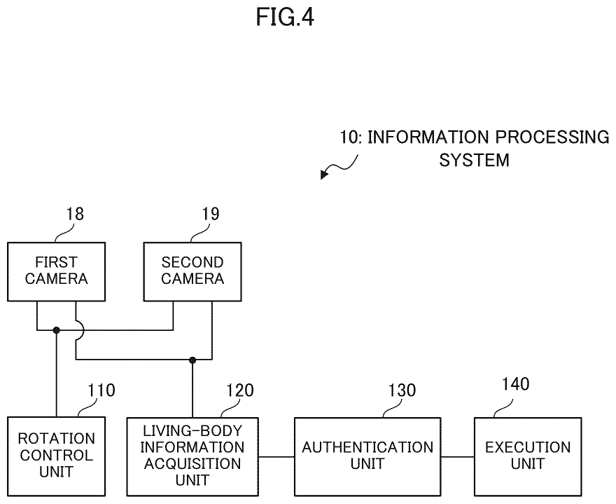

Next, a functional configuration of the information processing system 10 according to the first example embodiment will be described with reference to FIG. 4. FIG. 4 is a block diagram showing the functional configuration of the information processing system according to the first example embodiment.

As shown in FIG. 4, the information processing system 10 according to the first example embodiment is configured by comprising, as components for realizing functions thereof, the first camera 18 and the second camera 19 which have been already described, a rotation control unit 110, a living-body information acquisition unit 120, an authentication unit 130, and an execution unit 140. The rotation control unit 110, the living body information acquisition unit 120, the authentication unit 130, and the execution unit 140 may be each a processing block realized by the processor 11 described above (see FIG. 1), for example.

The rotation control unit 110 is configured to control the rotational operation of the first camera 18 and the second camera 19. For example, the rotation control unit 110 is configured so as to determine the rotation direction and the rotation amount of the first camera 18 and the second camera 19 and to execute control depending on determined parameters. The rotation control unit 110 controls the rotational operation of the first camera 18 and the second camera 19 depending on the position of the target. The position of the target may be, for example, a position where the face of the target exists, or a position where the eyes of the target exist. The position of the target may be not only a position with respect to the height direction, but also may be a position with respect to the depth direction corresponding to the distance to the camera, or a position with respect to the lateral direction. Specifically, the rotational operation of the first camera 18 and the second camera 19 is controlled so that the target can be imaged by each of the first camera 18 and the second camera 19 (in other words, so that the target is included in the imaging range of each of the first camera 18 and the second camera 19). For example, in a case that the first camera 18 is a face camera for imaging the face of the target and the second camera 19 is an iris camera for imaging the iris of the target, the rotation control unit 110 controls the rotational operation of the first camera 18 and the second camera 19 so that the face of the target is included in the imaging range of the first camera 18 and the iris of the target is included in the imaging range of the second camera 19. The rotation control unit 110 may be configured so as to acquire the position of the target from the outside of the system. For example, the rotation control unit 110 may acquire the position of the target from various sensors. On the other hand, the information processing system 10 according to the first example embodiment may be configured so as to detect the position of the target within the system. The configuration of this case will be described in detail in the following modifications.

### (Modification)

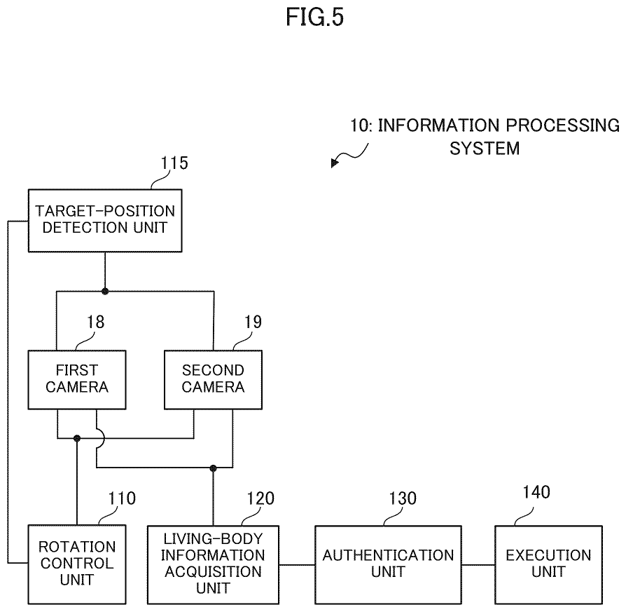

Here referring to FIG. 5, a modification of the information processing system 10 according to the first example embodiment will be described. FIG. 5 is a block diagram showing a functional configuration of the modification of the information processing system according to the first example embodiment. In FIG. 5, the reference signs same as in FIG. 4 are given to the components similar to in FIG. 4 respectively.

As shown in FIG. 5, the modification of the information processing system 10 according to the first example embodiment is configured by comprising, as components for realizing functions thereof, the first camera 18, the second camera 19, the rotation control unit 110, a target-position detection unit 115, the living-body information acquisition unit 120, the authentication unit 130, and the execution unit 140. That is, the information processing system 10 according to the modification is configured by, in addition to the configuration of the first example embodiment (cf. FIG. 4), further comprising the target-position detection unit 115. The target-position detection unit 115 may be a processing block executed by, for example, the processor 11 described above (cf. FIG. 1).

The target-position detection unit 115 is configured so as to acquire images taken by the first camera 18 and the second camera 19 to detect the position of the target (i.e. the target position) from at least one of the images. The target-position detection unit 115 may be configured so as to detect the position of the face or the position of the eyes with respect to the target from the face image taken by the face camera that is the first camera 18, for example. In a case that the first camera 18 is configured as the face camera and the second camera 19 is configured as the iris camera, the imaging range of each camera differs from each other (the imaging range of the face camera is wider). In such a case, the rotation may be controlled so that, first, the target position is detected by the first camera 18 (i.e. the face camera) whose imaging range is wide, and then the iris is imaged by the second camera 19 (i.e. the iris camera) whose imaging range is narrow.

The position of the target detected by the target-position detection unit 115 is configured to be outputted to the rotation control unit 110. Then, the rotation control unit 110, based on the position of the target detected by the target-position detection unit 115, performs the rotation control of the first camera 18 and the second camera 19. The position detection by the target-position detection unit 115 and the rotational operation by the rotation control unit 110 may be executed in parallel with each other at the same time. In this case, while the target is being imaged by the first camera 18 and the second camera 19, the position of the target may be detected, and at the same time, the rotational operation based on the detected position may be performed.

Returning to FIG. 4, the living-body information acquisition unit 120 is configured so as to acquire first living body information from the image taken by the first camera 18 (hereinafter, referred to as “the first image” as appropriate). Further, the living-body information acquisition unit 120 is configured so as to acquire second living body information from the image taken by the second camera 19 (hereinafter, referred to as “the second image” as appropriate). The first living body information may be the feature quantities of portions included in the images taken by the first camera 18 and the second camera 19 (that is, parameters indicating the feature quantities of portions of the living body). For example, in a case that the first camera 18 is the face camera for imaging the face of the target and the second camera 19 is the iris camera for imaging the iris of the target, the living-body information acquisition unit 120 may acquire the feature quantities of the face of the target from the first image (i.e. the face image) taken by the first camera 18 and the feature quantities of the iris of the target from the second image (i.e. the iris image) taken by the second camera 19. The living-body information acquisition unit 120 is configured so that each of the first living body information and the second living body information, which has been acquired by the living-body information acquisition unit 120, is outputted to the authentication unit 130.

The authentication unit 130 is configured so as to perform authentication processing on the target, using the first living body information and the second living body information each having been acquired by the living-body information acquisition unit 120. For example, the authentication unit 130 is configured so as to determine whether or not the target is a registered user by comparing the first living body information and the second living body information to living body information registered in advance. Further, the authentication unit 130 may be configured so as to determine whether or not the target is a living body (e.g. whether or not an impersonation using a photograph, a moving image, a mask, or the like is being performed) using the first living body information and the second living body information. The impersonation may be determined in such a manner that by instructing the target to perform a predetermined motion (for example, by giving the target instructions such as: “shake your neck sideways”; “turn your gaze upward”; or the like), and then the impersonation may be determined depending on whether or not the target is moving as instructed. Alternatively, the impersonation may be determined by using a thermo-image to determine whether or not the target has the body temperature and/or whether or not there is height information on each portion (e.g. the eyes, the nose, the mouth, etc.) of the target (i.e. whether or not each of the portions is a photographic plane). The authentication unit 130 may execute the authentication processing using the first living body information and the authentication processing using the second living body information separately, and integrate the authentication results thereof to acquire the final authentication result. For example, the authentication unit 130 may determine the final authentication result is successful when both the authentication processing using the first living body information and the authentication processing using the second information are successful. Further, the authentication unit 130 may determine the final authentication result is failed, when at least one of the authentication processing using the first living body information and the authentication processing using the second living body information is failed. The authentication unit 130 is configured so that the authentication result by the authentication unit 130 is outputted to the execution unit 140.

The execution unit 140 is configured so as to execute predetermined processing in a facility based on the authentication result of the authentication unit 130. The “facility” here is a facility which is used by the target, and may be, for example: a residential facility such as an apartment building; a store such as a retail store; an office of a company; a bus terminal; an airport; a facility for holding various events; or the like. The facility is not limited to indoor one only and may be an outdoor one such as, for example, a park or an amusement park. In addition, the “predetermined processing” includes various processing that can be executed in the facility, and may be, for example, processing that controls equipment of the facility. In this case, the predetermined processing may be processing performed at more than one facility. The predetermined processing may include more than one kind of processing. Specific examples of the predetermined processing will be described in detail in example embodiments described later. For example, the execution unit 140 may execute the predetermined processing when the authentication processing by the authentication unit 130 is successful, and may not execute the predetermined processing when the authentication processing by the authentication unit 130 is failed. Alternatively, the execution unit 140 may execute first predetermined processing when the authentication processing by the authentication unit 130 is successful, and may execute second predetermined processing (i.e. different from the first predetermined processing) when the authentication processing by the authentication unit 130 is failed.

### (Flow of Operation)

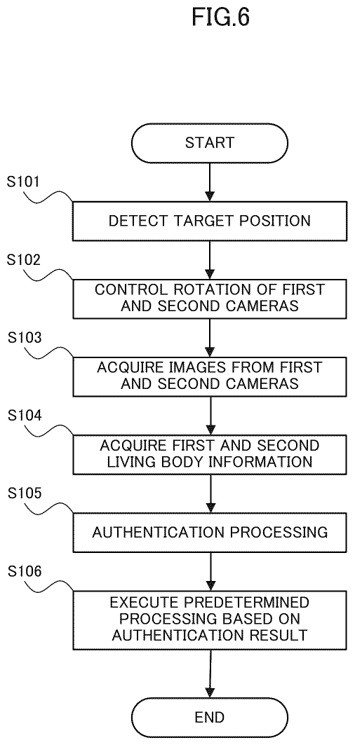

Next, referring to FIG. 6, a flow of operation by the information processing system 10 according to the first example embodiment will be described. FIG. 6 is a flowchart showing the flow of the operation by the information processing system according to the first example embodiment.

As shown in FIG. 6, when the information processing system 10 according to the first example embodiment is operated, first, the rotation control unit 110 detects the position of the target (step S101). Then, the rotation control unit 110, depending on the target position detected, controls the rotation of the first camera 18 and the second camera 19 (step S102). The first camera 18 and the second camera 19 may each take image at the timing when the control by the rotation control unit 110 is completed. In this case, the first camera 18 and the second camera 19 may take image at the same time, or may take image at different timing from each other. Further, the first camera 18 and the second camera 19 may take image in the middle of the control by the rotation control unit 110. For example, the first camera 18 and the second camera 19, in a situation where the rotational control by the rotation control unit 110 is continued, may take image more than one time.

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the Authentication unit 130 performs the authentication processing using the first living body information and the second living body information which have been acquired by the living-body information acquisition unit 120 (step S105). Then, the execution unit 140 executes the predetermined processing in the facility based on the authentication result in the authentication unit 130 (step S106).

### (Technical Effects)

Next, technical effects obtained by the information processing system 10 according to the first example embodiment will be described.

As described with respect to FIGS. 1 to 6, in the information processing system 10 according to the first example embodiment, the first camera 18 and the second camera 19 are rotated around the same rotational axis to acquire the image of the target. Thus, if the two cameras are rotated on the same rotational axis, their imaging range can be adjusted together. Therefore, the apparatus configuration can be simplified and the apparatus can be miniaturized, compared with a case where the two cameras are driven separately, for example. In addition, since the two cameras are driven in the same direction, it is easy to image the same target by each camera. In other words, it is possible to avoid such a situation that the two cameras image different target.

In the present example embodiment, further, the first living body information and the second living body information are acquired from the images taken by the first camera 18 and the second camera 19, and based on the authentication result using both kinds of living body information, the predetermined processing in the facility is executed. By this way, it is possible to execute the authentication processing with high accuracy with respect to the target that intends to use the facility, and thereby performing properly the predetermined processing. For example, when the target is the registered user, it is determined that the predetermined processing may be executed for the user, thereby allowing to execute the predetermined processing. When the target is not the registered user or the user is determined as the impersonation, it is determined that the predetermined processing should not be executed for the user, thereby preventing the predetermined processing from being executed.

### Second Example Embodiment

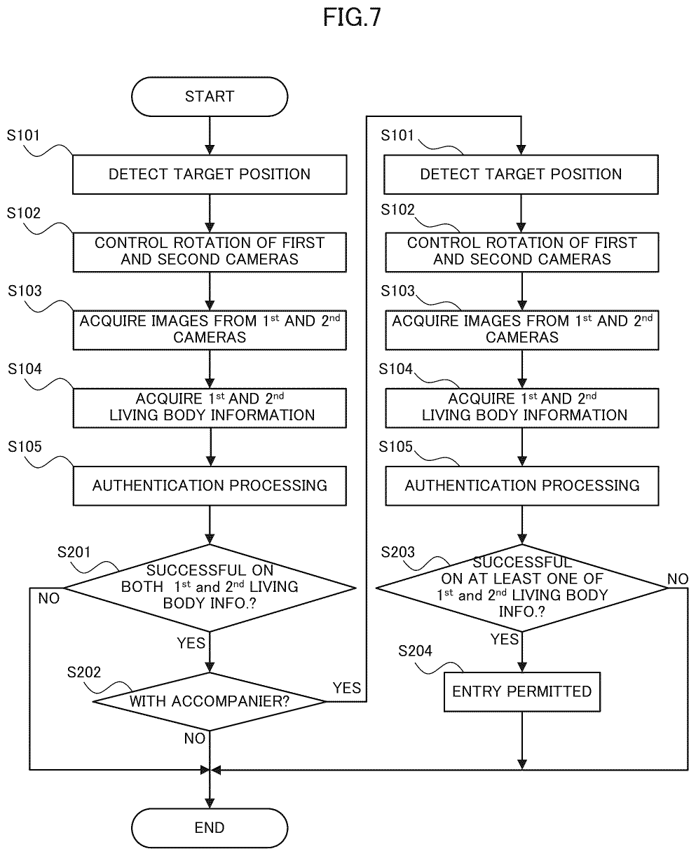

The information processing system 10 according to a second example embodiment will be described with reference to FIG. 7. The second example embodiment differs from the first example embodiment described above only in a part of operations, and the other parts may be the same as those in the first example embodiment. Therefore, the part that differs from the first example embodiment described above will be described in detail below, and the other overlapping parts will not be described as appropriate.

### (Contents of Predetermined Processing)

First, the contents of the predetermined processing executed in the information processing system 10 according to the second example embodiment.

In the information processing system 10 according to the second example embodiment, the execution unit 140 executes processing that permits entry into the facility as the predetermined processing. Specifically, the execution unit 140 permits the target to enter the facility (or enter a predetermined area of the facility) in a case that the authentication processing in the authentication unit 130 is successful. On the other hand, if the authentication processing in the authentication unit 130 is failed, the execution unit 140 does not allow the target to enter the facility (or enter the predetermined area of the facility) (in other words, prohibits entry to the facility). Specific examples of processing for allowing the entry includes processing of releasing the automatic lock at the entrance of an apartment building. In this case, when the authentication processing by the authentication unit 130 is successful (for example, when the target is a resident of the apartment building or a guest registered in advance), the execution unit 140 releases the automatic lock of the entrance and permits the target to enter the interior of the apartment building. In addition, when the authentication processing by the authentication unit 130 is failed (for example, when the target is not a resident of the apartment building or a fraud such as the impersonation is being performed), the execution unit 140 does not release the automatic lock of the entrance and does not permit the target to enter the interior of the apartment building. At the moment of the entry of the target, the authentication processing may be performed more than one time. For example, the first authentication processing may be performed at the entrance on the first floor of an apartment building, and the second authentication processing may be performed in front of the room (in other words, the apartment) on the floor where the target resides. When the authentication processing is executed more than one time in this way, the number of and the type of modals to be used may be changed. For example, with respect to the first authentication processing performed at the entrance, the entry may be permitted when the facial authentication is successful, and with respect to the second authentication processing performed in front of the room, the entry may be permitted when both facial authentication and iris authentication are successful.

### (Flow of Operation)

Next, referring to FIG. 7, a flow of operation by the information processing system 10 according to the second example embodiment will be described. FIG. 7 is a flowchart showing the flow of the operation by the information processing system according to the second example embodiment. In FIG. 7, the reference signs same as in FIG. 6 are given to the processes similar to in FIG. 6 respectively.

As shown in FIG. 7, when the information processing system 10 according to the second example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201). If both of them are not successful (step S201: NO), the subsequent processes are omitted and a series of operation ends. That is, if either the authentication processing using the first living body information or the authentication processing using the second living body information is failed, the predetermined processing is not executed (i.e. the target is not permitted to enter the facility).

On the other hand, when both authentication processing are successful (step S201: YES), the execution unit 140 determines whether or not there is an accompanier of the target whose entry has been permitted (step S202). Whether or not there is the accompanier may be determined by, for example, whether or not there is the other target in the periphery of the target (e.g. within a predetermined distance from the target). In this case, the presence of the other target may be detected from the image(s) taken by the first camera 18 and/or the second camera 19. For example, when more than one person is captured in the images taken by the first camera 18 and the second camera 19 (for example, when more than one face is detected from the images), the execution unit 140 may determine that there is the accompanier of the target. Alternatively, the presence of the other target may be determined by a declaration made by the target whose authentication processing is successful. For example, when the target operates the terminal to input that there is the accompanier of the target (for example, when a button “with accompanier” displayed on a touch panel is pressed), the execution unit 140 may determine that there is the accompanier of the target. In addition, the declaration with respect to the presence or absence of the accompanier may be enabled in a non-contact manner. For example, the presence or absence of the accompanier may be declared by user's gesture. In this case, for example, it may be possible to declare the number of accompaniers in addition to the presence or absence of accompanies, by raising two fingers if there are two accompaniers, raising four fingers if there are four accompaniers, and the like. Further, if a suspicious person exists nearby and it is desired to send the SOS signal by stealth (unnoticed by the suspicious person), the system 10 may make the target perform a particular gesture. For example, when the target performs a gesture such as covering the right eye with a hand or the like, an alert indicating the presence of the suspicious person may be received by a concierge or security guard of the apartment building, or the like. In a case that there is no accompanier (step S202: NO), the following processes are omitted and a series of operation ends.

On the other hand, when there is the accompanier (step S202: YES), the information processing system 10 according to the second example embodiment executes the similar processes also for the accompanier. Specifically, the rotation control unit 110 detects the position of the target (the accompanier) (step S101). Then, the rotation control unit 110, depending on the target (accompanier) position detected, controls the rotation of the first camera 18 and the second camera 19 (step S102).

Subsequently, the living-body information acquisition unit 120 acquires the images (i.e. the first image and the second image) taken by the first camera 18 and the second camera 19 with respect to the accompanier (step S103). Then, the living-body information acquisition unit 120 acquires the first living body information of the accompanier from the first image taken by the first camera 18, and acquires the second living body information of the accompanier from the second image taken by the second camera 19 (step S104).

Subsequently, the authentication unit 130 performs the authentication processing using the first living body information of the accompanier and the second living body information of the accompanier which have been acquired by the living-body information acquisition unit 120 (step S105). Here, in particular, the execution unit 140 determines whether or not at least one of the authentication processing using the first living body information and the authentication processing using the second living body information is successful in the authentication unit 130 (step S203). That is, whereas for the first target it is determined whether or not both the authentication processing using the first living body information and the authentication processing using the second living body information are successful in the authentication unit 130, for the accompanier it is determined whether or not at least one of the authentication processing using the first living body information and the authentication processing using the second living body information is successful.

Then, in a case that at least one authentication processing is successful (step S203: YES), the execution unit 140 permits the target and the accompanier to enter the facility (step S204). Therefore, when the target takes the accompanier, merely successful authentication on the target is not enough to permit the entry, and if the authentication on the accompanier is also successful, the entry is permitted. However, with respect to the accompanier, even in a case that either one of the authentication processing using the first living body information and the authentication processing using the second living body information is failed, if the other one is successful, the entry is permitted. For example, in a case that both the facial authentication and the iris authentication are successful with respect to the target, if with respect to the accompanier only the facial authentication is successful, the entry of them may be permitted. In a case that both authentication processing are failed (step S204: NO), the execution unit 140 does not permit the target and the accompanier to enter the facility. In a case there is more than one accompanier, the authentication processing may be executed sequentially for each accompanier, otherwise, the authentication processing may be executed collectively. For example, the authentication processing may be performed by taking image more than one time in the order of closeness to the first camera 18 and the second camera 19. The authentication processing may be executed collectively by detecting all accompaniers included in the imaging ranges of the first camera 18 and the second camera 19 (to take image only one time).

Although the example the processing is performed for the accompanier of the target has been described in the above-described example, the accompanier may be the other user who does not accompany the target. That is, the processing described above may be performed with respect to the other user that differs from the target.

### (Technical Effects)

Next, technical effects obtained by the information processing system 10 according to the second example embodiment will be described.

As described in FIG. 7, in the information processing system 10 according to the second example embodiment, the authentication processing is performed for each of the target and the accompanier to determine whether or not the entry to the facility is permitted. In the second example embodiment, in particular, with respect to the accompanier accompanying the target, the entry to the facility is permitted under requirements laxer than the target. Thereby, even if, for example, there is a shortage of registered information concerning the accompanier, it is possible to permit appropriately the entry. For example, in a case that the target, a resident of the apartment building, takes the accompanier who is a guest (i.e. a user having some relation with the target: for example, a user having business relation such as a housekeeper, a helper, a home teacher, or the like, in addition to a friend or acquaintance of the target, is included), if the first living body information (e.g. the facial information) of the guest has been registered, even if the second living body information (e.g. the iris information) of the guest has not been registered, the entry could be permitted with respect to the accompanier. That is, though the iris image is difficult to be registered in comparison with the face image (for example, cameras capable of taking the iris image are limited), the entry could be permitted with respect to the accompanier with only the face image whose registration is relatively simple. While with respect to the accompanier the requirements for entry permission are lax, with respect to the target, the authentication processing using both the first living body information and the second living body information is performed. Thereby, it is possible to suppress reducing security. On the other hand, even for the accompanier, it is required to succeed in the authentication processing with respect to at least one of the first living body information and the second living body information. Thereby, it is possible to prevent the entry of unintentional third parties is permitted (so-called, tailgating).

### Third Example Embodiment

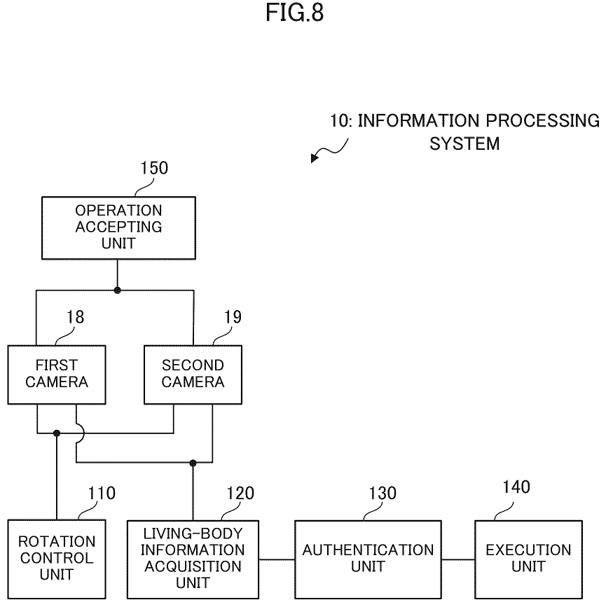

The information processing system 10 according to a third example embodiment will be described with reference to FIG. 8. The third example embodiment differs from the above-described first and second example embodiments in a part of the configuration and operation, and the other parts may be the same as those of the first and second example embodiments. Therefore, the part that differs from the example embodiments described above will be described in detail below, and the other overlapping parts will not be described as appropriate.

### (Functional Configuration)

Next, a functional configuration of the information processing system 10 according to the third example embodiment will be described with reference to FIG. 8. FIG. 8 is a block diagram showing a functional configuration of an information processing system according to the third example embodiment. In FIG. 8, the reference signs same as in FIG. 4 are given to the components similar to in FIG. 4 respectively.

As shown in FIG. 8, the information processing system 10 according to the third example embodiment is configured by comprising, as components for realizing functions thereof, the first camera 18, the second camera 19, the rotation control unit 110, the living-body information acquisition unit 120, the authentication unit 130, the execution unit 140, and an operation accepting unit 150. That is, the information processing system 10 according to the third example embodiment is configured by further comprising the operation accepting unit 150 in addition to the components of the first example embodiment (c.f. FIG. 4). The operation accepting unit 150 may be, for example, a processing block executed by the processor 11 described above (c.f. FIG. 1).

The operation accepting unit 150 is configured so as to accept operations from a user in the facility (for example, a user in the room that has received a call by an intercom). The operation accepting unit 150 is configured so as to control the rotation of the first camera 18 and second camera 19 in response to the operations of the user. The rotation control by the operation accepting unit 150 is a control performed separately from the rotation control by the rotation control unit 110. The operation accepting unit 150, for example, after the rotation control by the rotation control unit 110 is completed, in response to the operations of the user, may control the rotation of the first camera 18 and second camera 19. Alternatively, the operation accepting unit 150, before the rotation control by the rotation control unit 110 is started, in response to the operations of the user, may control the rotation of the first camera 18 and second camera 19. The operation accepting unit 150 may be configured as an intercom installed in a room, for example. Alternatively, the operation accepting unit 150 may be configured to accept operations from an application installed in user's terminal (for example, a smartphone, or the like).

In a case that the rotation of the first camera 18 and second camera 19 is controlled by the operation accepting unit 150, operation of the system after the rotation control may also be executed in response to operations accepted by the operation accepting unit 150. For example, the authentication processing using the images taken by the first camera 18 and the second camera 19 may be started in response to an operation accepted by the operation accepting unit 150. More specifically, when the user performs an operation of rotating the first camera 18 and second camera 19, a message such as “Request Authentication?” or the like is displayed on the terminal. Then, when the user touches a button indicating that the user requests the authentication (for example, a button of “AGREE” or “YES”), the authentication processing starts at that timing. In this way, the target can be checked by the authentication processing. Thereby, it is possible to check the target more reliably than a case of checking by reviewing visually an image.

Here, an example that the information processing system 10 according to the third example embodiment is applied to an entrance of an apartment building, will be described. At the entrance of the apartment building, the image of the target (i.e. a user who intends to enter the apartment building) is taken by the first camera 18 and second camera 19. For example, the face of the target is imaged by the first camera 18, and the iris of the target is imaged by the second camera 19. In this case, the rotation control unit 110 executes control so that each of the first camera 18 and the second camera 19 faces the target. It is assumed that the images captured by the first camera 18 and the second camera 19 can be checked by a resident of the apartment building.

In a case that the rotational control is performed as described above, the first camera 18 and the second camera 19 may be directed to the face of the target, so that the other parts would not enter the imaging ranges. For example, the surrounding of the target's hand would be invisible; it would be impossible to recognize what the target has. Alternatively, a user having a short stature (e.g. a child) would be invisible. In such a case, the resident of the apartment building operates the imaging angle with respect to the first camera 18 and the second camera 19. For example, the resident of the apartment building is allowed to move the first camera 18 and the second camera 19 downward to check whether or not the target has anything in his/her hand, whether or not the target takes a child, or the like. Further, in a case that the first camera 18 or the second camera 19 cannot rotate normally due to system failure or the like, by performing the rotational control manually, the first camera 18 and second camera 19 are possible to be directed in an appropriate direction (e.g. the direction of the face). In this case, besides the resident of the room in the apartment building, a manager (a concierge, etc.) may be also able to perform the manually rotational control with respect to the first camera 18 and second camera 19. For example, in a case that the first camera 18 and second camera 19 do not rotate normally, the resident of the apartment building touches a communication button displayed on the display of the control terminal (that is, the terminal comprising the operation accepting unit 150). Then, the concierge would be connected, thereby allowing the resident to inform the concierge of the system failure, or to ask the concierge to perform the rotational control manually.

### (Technical Effects)

Next, technical effects obtained by the information processing system 10 according to the third example embodiment will be described.

As described in FIG. 8, in the information processing system 10 according to the third example embodiment, the user in the facility is allowed to control the rotation of the first camera 18 and second camera 19. By this way, the user in the facility is allowed to confirm a portion which is invisible under the normal rotational control (i.e. the rotational control by the rotation control unit 110). Therefore, it is possible to realize the improvement of convenience and security function of the user. Further, the first camera 18 and the second camera 19 are rotatable, thereby allowing the user to check a wider range as compared with a not-rotatable camera.

### Fourth Example Embodiment

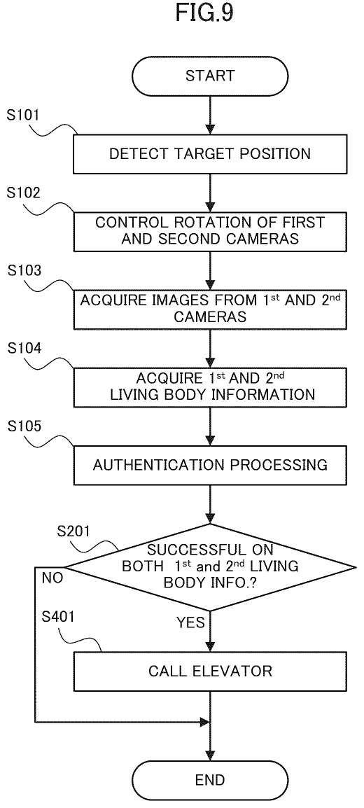

The information processing system 10 according to a fourth example embodiment will be described with reference to FIG. 9. The fourth example embodiment differs from the above-described first to third example embodiments in a part of the configuration and operation, and the other parts may be the same as those of the first to third example embodiments. Therefore, the part that differs from the example embodiments described above will be described in detail below, and the other overlapping parts will not be described as appropriate.

### (Contents of Predetermined Processing)

First, the contents of a predetermined processing executed in the information processing system 10 according to the fourth example embodiment.

In the information processing system 10 according to the fourth example embodiment, the execution unit 140 executes processing of calling an elevator to a specified floor as the predetermined processing. Specifically, the execution unit 140 executes processing of calling the elevator to the floor corresponding to the position of the target whose authentication processing is successful. For example, in a case that the authentication on the target is successful at the first-floor entrance, the execution unit 140 may execute the processing of calling the elevator to the first floor (i.e. the floor where target is located). However, in a case that the elevator cannot be called to the floor where target is located (for example, the elevator is available only on the second floor), there may be performed processing of calling the elevator to the nearest floor of the target. Alternatively, in a case that it has been known that the target does not take the elevator immediately after authentication (e.g. in a case that it is expected that the target will take the elevator after going up to the second floor and finishing what to do), there may be performed processing of calling the elevator to the floor where the target is expected to get on the elevator. The processing of calling the elevator may be performed together with the processing (c.f. the second example embodiment) of permitting the entry to the facility already described. That is, the execution unit 140 may execute, as the predetermined processing, the processing of permitting the entry and the processing of calling the elevator. In this case, when it is detected that the number of users who have been permitted with respect to the entry is equal to or greater than a predetermined number, more than one elevator may be called. The predetermined number may be the number corresponding to the capacity of the elevator. For example, in a case that the capacity of the elevator is five, when detecting six or more users, the execution unit 140 may call two elevators.

### (Flow of Operation)

Next, referring to FIG. 9, a flow of operation by the information processing system 10 according to the fourth example embodiment will be described. FIG. 9 is a flowchart showing the flow of the operation by the information processing system according to the fourth example embodiment. In FIG. 9, the reference signs same as in FIG. 7 are given to the processes similar to in FIG. 7 respectively.

As shown in FIG. 9, when the information processing system 10 according to the fourth example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case that both of them are successful (step S201: YES), the execution unit 140 executes the processing of calling the elevator to the floor corresponding to the target position (step S401). On the other hand, in a case that both of them are not successful (step S201: NO), the subsequent processes are omitted and a series of operation ends. That is, if either the authentication processing using the first living body information or the authentication processing using the second living body information is failed, the processing of calling the elevator to the floor corresponding to the target position is not executed.

### (Technical Effects)

Next, a description will be given of technical effects obtained by the information processing system 10 according to the fourth example embodiment.

As described in FIG. 9, in the information processing system 10 according to the fourth example embodiment, when the authentication processing on the target is successful, the processing of calling the elevator to the floor corresponding to the position of the target is executed. This could reduce the time the target waits for the elevator; allowing the target to move smoothly in the facility.

### Fifth Example Embodiment

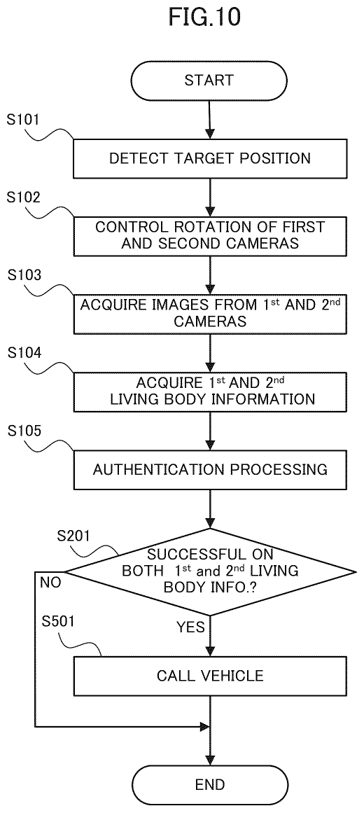

The information processing system 10 according to a fifth example embodiment will be described with reference to FIG. 10. The fifth example embodiment differs from the above-described first to fourth example embodiments in a part of the configuration and operation, and the other parts may be the same as those of the first to fourth example embodiments. Therefore, the part that differs from the example embodiments described above will be described in detail below, and the other overlapping parts will not be described as appropriate.

### (Contents of Predetermined Processing)

First, the contents of the predetermined processing executed in the information processing system 10 according to the fifth example embodiment will be described.

In the information processing system 10 according to the fifth example embodiment, the execution unit 140 executes processing of calling a vehicle to be used by the target to a predetermined position as the predetermined processing. The “vehicle” here has a wide range of concept, including a vehicle, a motorbike, a bicycle, a ship, an airplane, a helicopter, and the other mobile object to be used by the target. For example, in a case that the authentication on the target is successful at the timing of leaving the entrance of his/her home, the execution unit 140 may issue an instruction to make the vehicle owned by the target (e.g. the vehicle previously linked with the target) leave a mechanical parking and move to a driveway apron. The timing of the leaving parking is not limited to the timing immediately before leaving the entrance. For example, when the target gets out the entrance and then by an authentication terminal arranged in front of a door the authentication is successful, the door may be locked and the vehicle may be made to leave the parking. In addition, in a case that an instruction to leave the parking is outputted by an application on the smartphone, it may be possible to make reservation of the leaving time, for example, so as to make the vehicle leave the parking 30 minutes later. Furthermore, in a case that there is a possibility that the target does not use the vehicle (e.g. there is a possibility that walking or other traffic unit is selected), the execution unit 140 may perform processing of confirming whether or not the target is going to use the vehicle. For example, the execution unit 140 may show on the terminal (for example, the smartphone), display for confirming whether or not the target is going to use the vehicle owned by the target. For example, when the authentication processing is successful, a message such as “Make Car Leave Parking?” may be displayed on the terminal. In this case, the execution unit 140 may execute the processing of calling the vehicle to the predetermined position when the target inputs to indicate that the target is going to use the vehicle. In other words, the execution unit 140 may not execute the processing of calling the vehicle to the predetermined position when the target inputs to indicate that the target is going not to use the vehicle (or when nothing is inputted). Also, in a case that there is more than one vehicle that the target may use (e.g. in a case that the target owns more than one vehicle), the execution unit 140 may perform processing of making the target select the vehicle to be used. Further, the execution unit 140, rather than actually making the vehicle leave the parking, may perform preparation of leaving the parking for immediate leaving. For example, in a case that vehicle is located on the tenth basement floor, there may be performed processing of moving the vehicle to a portion close to the ground, such as the second basement floor. Even if the authentication processing is successful, in a case that the target has gone somewhere without using the vehicle (e.g. when the vehicle has not been used even after a predetermined time has elapsed), the execution unit 140 may return the vehicle to the position before the leaving.

### (Flow of Operation)

Next, referring to FIG. 10, a flow of operation by the information processing system 10 according to the fifth example embodiment will be described. FIG. 10 is a flowchart showing the flow of the operation by the information processing system according to the fifth example embodiment. In FIG. 10, the reference signs same as in FIG. 7 are given to the processes similar to in FIG. 7 respectively.

As shown in FIG. 10, when the information processing system 10 according to the fifth example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case that both of them are successful (step S201: YES), the execution unit 140 executes the processing of calling the vehicle the target is going to use to the predetermined position (step S401). On the other hand, in a case that both of them are not successful (step S201: NO), the subsequent processes are omitted and a series of operation ends. That is, if either the authentication processing using the first living body information or the authentication processing using the second living body information is failed, the processing of calling the elevator to the floor corresponding to the target position is not executed.

### (Technical Effects)

Next, a technical effect obtained by the information processing system 10 according to the fifth example embodiment will be described.

As described in FIG. 10, in the information processing system 10 according to the fifth example embodiment, in a case that the authentication processing on the target is successful, the processing of calling the vehicle to be used by the user to the predetermined position is executed. By this way, it is possible for the target to use the vehicle more smoothly, since the waiting time when calling the vehicle is reduced, or since the trouble such the target himself/herself moves the vehicle is saved.

### Sixth Example Embodiment

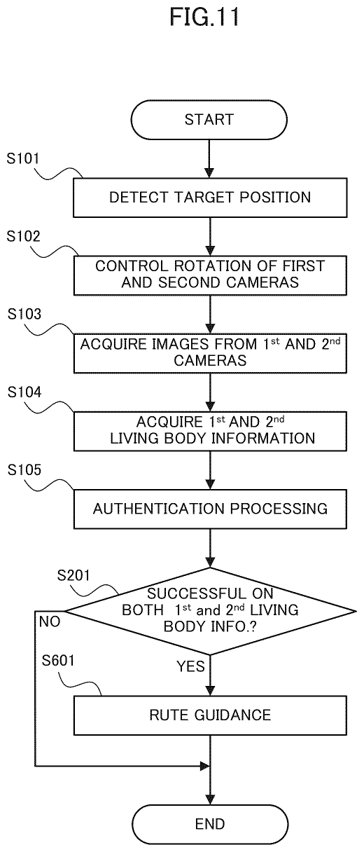

The information processing system 10 according to a sixth example embodiment will be described with reference to FIG. 11. The sixth example embodiment differs from the above-described fifth example embodiment in a part of the configuration and operation, and the other parts may be the same as those of the first to fifth example embodiments. Therefore, the part that differs from the example embodiments described above will be described in detail below, and the other overlapping parts will not be described as appropriate.

### (Contents of Predetermined Processing)

First, the contents of the predetermined processing executed in the information processing system 10 according to the sixth example embodiment will be described.

In the information processing system 10 according to the sixth example embodiment, the execution unit 140 executes processing of guiding a route in the facility to the target as the predetermined processing. Specifically, when the target moves within the facility, the execution unit 140 executes the processing of guiding a route so that the target and the other user do not pass each other. The execution unit 140 may display a facility map on a terminal (for example, a smartphone, or the like) owned by the target and superimpose the route to be traveled thereon. In addition, when the target moves from a floor to the other floor within the facility, the elevator to be got on may be displayed. The route to be guided may be a route outside the facility. For example, a proposal may be made such as “Exit from the apartment building using the second back door” so that the target and the other user do not pass each other inside the apartment building. In addition to the route, instructions with respect to time information may also be given. For example, the following instructions may be issued: “Start 5 min later because of current congestion” or “Pass this route 3 min. later and get on the elevator 5 min. later.”. Such a route guidance may be realized, for example, by using a surveillance camera or the like installed in the facility to monitor positions of the other users in the facility. In a case that it is difficult to avoid all of the other users, the execution unit 140 may guide a route so that the target will pass as few other users as possible. Further, with respect to the other user pre-specified by the target (e.g. a member of family or a facility management staff), it may be permitted to pass the other user. The processing of guiding the route may be executed together with the above-described processing (see the fourth example embodiment) of calling the elevator and the above-described processing (see the fifth example embodiment) of calling the vehicle.

### (Flow of Operation)

Next, referring to FIG. 11, a flow of operation by the information processing system 10 according to the sixth example embodiment will be described. FIG. 11 is a flowchart showing the flow of the operation by the information processing system according to the sixth example embodiment. In FIG. 11, the reference signs same as in FIG. 7 are given to the processes similar to in FIG. 7 respectively.

As shown in FIG. 11, when the information processing system 10 according to the sixth example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case that both of them are successful (step S201: YES), the execution unit 140 executes the processing of guiding the target through the traveling route in the facility (step S601). On the other hand, in a case that both of them are not successful (step S201: NO), the subsequent processes are omitted and a series of operation ends. That is, if either the authentication processing using the first living body information or the authentication processing using the second living body information is failed, the processing of guiding the target through the traveling route in the facility is not executed.

### (Technical Effects)

Next, a description will be given of technical effects obtained by the information processing system 10 according to the sixth example embodiment.

As described in FIG. 11, in the information processing system 10 according to the sixth example embodiment, in a case that the authentication processing on the target is successful, the processing of guiding the target with respect to the traveling route within the facility is executed. By this way, it is possible to avoid the target from passing the other users in the facility. Such benefits will be significant in a case that the target wishes to behave in hiding within the facility (e.g. in a case that target is a famous person, and the like).

### Seventh Example Embodiment

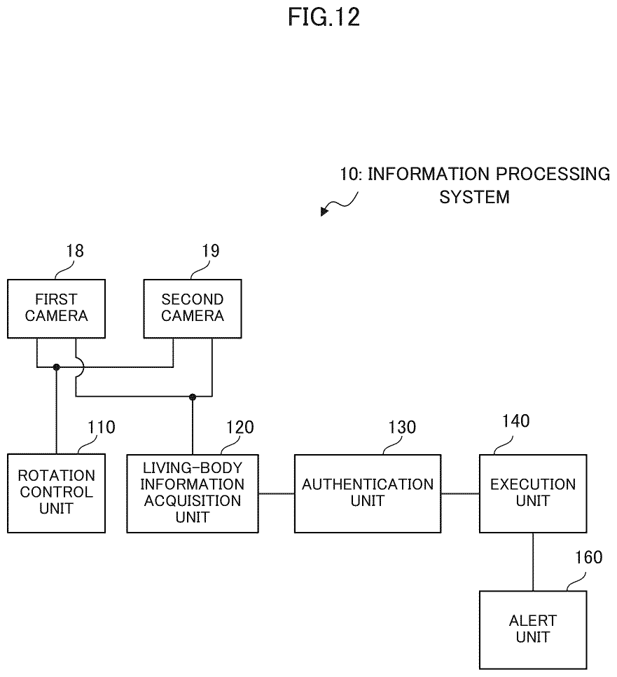

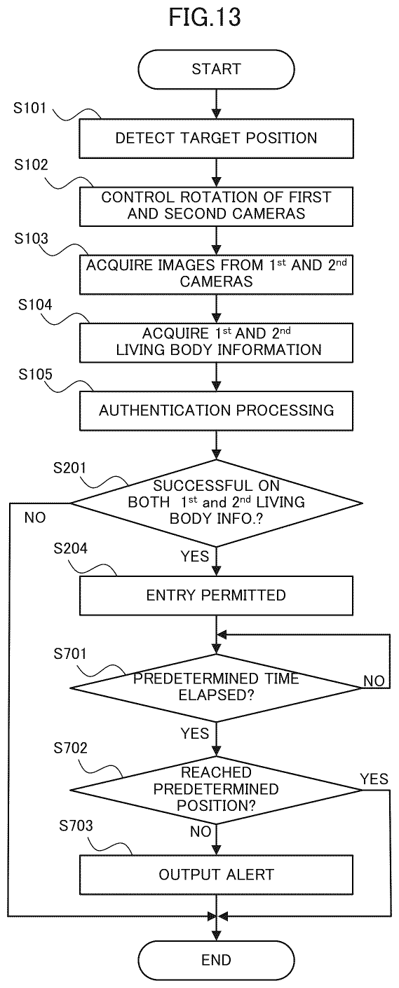

The information processing system 10 according to a seventh example embodiment will be described with reference to FIGS. 12 and 13. The seventh example embodiment differs from the above-described first to sixth example embodiments in a part of the configuration and operation, and the other parts may be the same as those of the first to sixth example embodiments. Therefore, the part that differs from the example embodiments described above will be described in detail below, and the other overlapping parts will not be described as appropriate.

### (Functional Configuration)

First, a functional configuration of the information processing system 10 according to the seventh example embodiment will be described with reference to FIG. 12. FIG. 12 is a block diagram showing the functional configuration of the information processing system according to the seventh example embodiment. In FIG. 12, the reference signs same as in FIG. 4 are given to the components similar to in FIG. 4 respectively.

As shown in FIG. 12, the information processing system 10 according to the seventh example embodiment is configured by comprising, as components for realizing functions thereof, the first camera 18, the second camera 19, the rotation control unit 110, the living-body information acquisition unit 120, the authentication unit 130, the execution unit 140, and an alert unit 160. That is, the information processing system 10 according to the seventh example embodiment is configured by further comprising the alert unit 160 in addition to the components of the first example embodiment (c.f. FIG. 4). The alert unit 160 may be, for example, a processing block executed by the processor 11 described above (c.f. FIG. 1).

The alert unit 160 is configured so as to output an alert in a case that the target does not reach a predetermined position in a predetermined time after the authentication processing on the target has succeeded. The “predetermined position” here is a position set as a position which the target whose authentication processing is successful is predicted to reach (e.g. the destination of the target). The “predetermined time” is time that is set depending on the time (which may include some margins) required for the target to reach the predetermined position. For example, in a case that target's authentication processing is successful at the entrance of the apartment building, the alert unit 160 may output an alert if the target does not reach a particular room (e.g. his/her home or destination) in the apartment building in a predetermined time. The alert may indicate, for example, that something error has occurred with respect to the target. The alert unit 160 may issue the alert to the facility management staff or the like. The alert unit 160 may issue the alert to the target himself/herself or to the user who is the destination of the target. The alert by the alert unit 160 may be, for example, an alert display using a display, or may be an output of an alert sound using a speaker. Further, more than one predetermined time may be set. In a case that the target does not reach the predetermined position by the first predetermined time, the first alert (e.g. a rather weak alert) is issued, and in a case that the target does not reach the predetermined position by the second predetermined time, the second alert (e.g. a rather strong alert) may be issued. To the target of the alert, a level of importance may be set. Since a guest is more likely to become lost than a resident familiar with the apartment building and there is a possibility that the guest commits a theft, the level of importance of the guest may be set to high. In this case, with respect to the target whose level of importance is high, the predetermined time until the alert is issued may be set short. Alternatively, with respect to the target whose level of importance is high, the alert may be enhanced (e.g. at the moment of the second alert, the concierge is always notified, or the like). Also, with respect to a child, an elderly person, or a user with sickness, even if he/she is a resident of the apartment building, a high level of importance may be set; the predetermined time until the alert is issued may be shorten, the alert may be enhanced, or the like.

### (Flow of Operation)

Next, referring to FIG. 13, a flow of operation by the information processing system 10 according to the seventh example embodiment will be described. FIG. 13 is a flowchart showing the flow of the operation by the information processing system according to the seventh example embodiment. In FIG. 13, the reference signs same as in FIG. 7 are given to the processes similar to in FIG. 7 respectively.

As shown in FIG. 13, when the information processing system 10 according to the seventh example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case that both of them are successful (step S201: YES), the execution unit 140 executes the processing of permitting the target to enter the facility (step S204). On the other hand, in a case that both of them are not successful (step S201: NO), the subsequent processes are omitted and a series of operation ends. That is, if either the authentication processing using the first living body information or the authentication processing using the second living body information is failed, the processing of permitting the target to enter the facility is not executed.

In a case that the entry to the facility is permitted to the target, the alert unit 160 determines whether the predetermined time has elapsed since the authentication succeeded (step S701). In a case that it is determined that the predetermined time has not elapsed (step S701: NO), the alert unit 160 continues the time measurement after the authentication succeeded. On the other hand, when it is determined that the predetermined time has elapsed (step S701: YES), the alert unit 160 determines whether or not the target has reached the predetermined position (step S702).

In a case the target has not reached the predetermined point (step S702: NO), the alert unit 160 outputs the alert (step S703). On the other hand, in a case that the target has already reached the predetermined position (step S702: YES), the alert unit 160 does not output the alert.

### (Technical Effects)

Next, technical effects obtained by the information processing system 10 according to the seventh example embodiment will be described.

As described in FIGS. 12 and 13, in the information processing system 10 according to the seventh example embodiment, in the case that the target does not reach the predetermined position in the predetermined time after the authentication succeeded, the alert is outputted by the alert unit 160. By this way, based on the elapsed time after the authentication, it is possible to give notice that some abnormality has occurred on the target. For example, it is possible to give notice that the target is being lost in the facility or is falling down due to bad physical condition.

### Eighth Example Embodiment

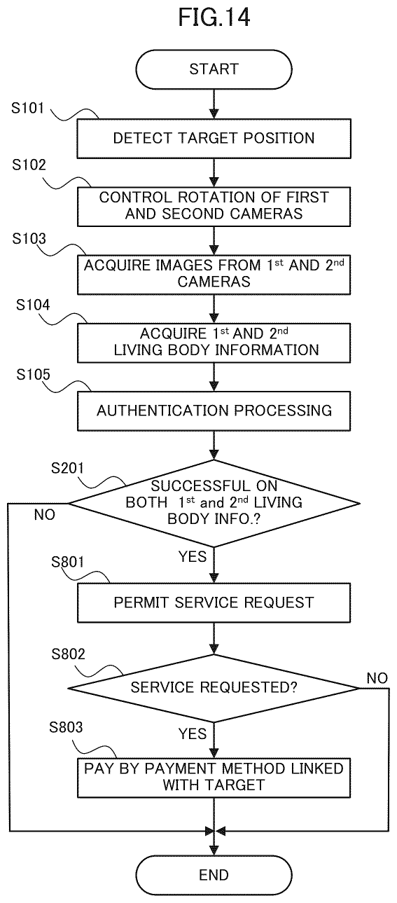

The information processing system 10 according to an eighth example embodiment will be described with reference to FIG. 14. The eighth example embodiment differs from the above-described first to seventh example embodiments in a part of the configuration and operation, and the other parts may be the same as those of the first to seventh example embodiments. Therefore, the part that differs from the example embodiments described above will be described in detail below, and the other overlapping parts will not be described as appropriate.

### (Contents of Predetermined Processing)

First, the contents of the predetermined processing executed in the information processing system 10 according to the eighth example embodiment will be described.

In the information processing system 10 according to the eighth example embodiment, the execution unit 140 executes processing of permitting a request for a predetermined service to the target as the predetermined processing. The “predetermined service” here may include payment processing (i.e. occurrence of expense) such as, for example, calling for a taxi, ordering food delivery, etc. The predetermined service may be requested from a terminal in the facility or a terminal (a smartphone) owned by the target after the target is authenticated. Further, when requesting the predetermined service, information (e.g. location information by GPS) indicating the position of the target whose authentication is successful, and/or information relating to the target (e.g. the name and address of the target, the room number, etc.) may be automatically informed to a service request destination.

The expense for the predetermined service requested is paid by a payment method linked with the target whose authentication is successful. For example, there may be executed automatic withdrawal from an account associated with the target specified by the authentication processing. Alternatively, there may be executed automatic payment processing using a credit-card associated with the target specified by the authentication processing. At the stage of requesting the service, there may be executed processing of confirming with the target himself/herself, whether or not the payment may be made by a payment method linked with the target.

### (Flow of Operation)

Next, referring to FIG. 14, a flow of operation by the information processing system 10 according to the eighth example embodiment will be described. FIG. 14 is a flowchart showing the flow of the operation by the information processing system according to the eighth example embodiment. In FIG. 14, the reference signs same as in FIG. 7 are given to the processes similar to in FIG. 7 respectively.

As shown in FIG. 14, when the information processing system 10 according to the eighth example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case that both of them are successful (step S201: YES), the execution unit 140 executes the processing of permitting the target to request the predetermined service (step S801). On the other hand, in a case that both of them are not successful (step S201: NO), the subsequent processes are omitted and a series of operation ends. That is, if either the authentication processing using the first living body information or the authentication processing using the second living body information is failed, the processing of permitting the target to request the predetermined service is not executed.

In a case that the target is permitted to request the predetermined service, the execution unit 140 determines whether or not the predetermined service has been requested by the target (step S802). Then, in a case that the predetermined service has been requested (step S802: YES), the expense of the service is paid by the payment method linked with the target (step S803). On the other hand, in a case the predetermined service is not requested (step S802: NO), the subsequent processes are omitted, and a series of operations ends.

### (Technical Effects)

Next, technical effects obtained by the information processing system 10 according to the eighth example embodiment will be described.

As described in FIG. 14, in the information processing system 10 according to the eighth example embodiment, in a case the authentication processing on the target is successful, the processing of permitting the target to request the predetermined service is executed, and the expense thereof is paid by a payment method linked with the target. By this way; it is possible to improve the target's convenience while enhancing security by biometric authentication. Further, by notifying the service request destination of information indicating the target position and/or information relating to the target, it is possible to spare the target the trouble of contacting separately such information to the service request destination.

### Ninth Example Embodiment

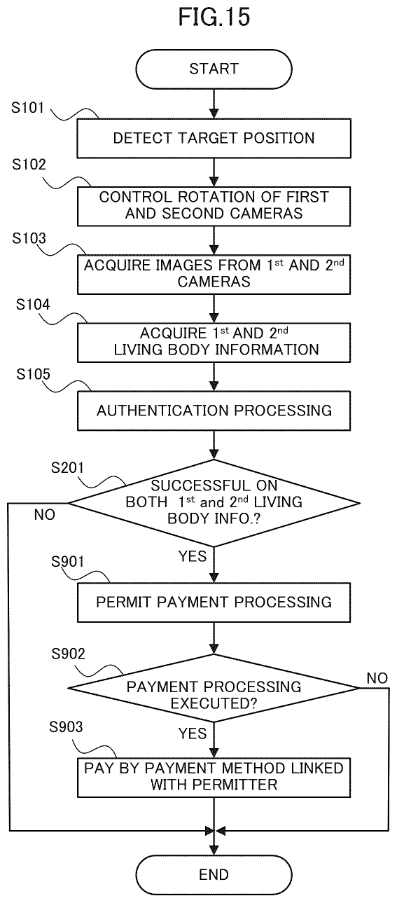

The information processing system 10 according to a ninth example embodiment will be described with reference to FIG. 15. The ninth example embodiment differs from the above-described first to eighth example embodiments in a part of the configuration and operation, and the other parts may be the same as those of the first to eighth example embodiments. Therefore, the part that differs from the example embodiments described above will be described in detail below, and the other overlapping parts will not be described as appropriate.

### (Contents if Predetermined Processing)

First, the contents of the predetermined processing executed in the information processing system 10 according to the ninth example embodiment will be described.

In the information processing system 10 according to the ninth example embodiment, the execution unit 140 executes processing of permitting payment processing by the target whose authentication is successful as the predetermined processing. The payment processing here is not particularly limited, but may be, for example, payment processing for purchasing goods in stores or vending machines.

When the target executes the payment processing, the expense will be paid by the payment method linked with a permitter who has permitted the target to execute the payment processing. In other words, the permitter will pay the expense instead of the target who has executed the payment processing. In a case the permitter executes the payment processing, the expense may be paid by the permitter. For example, parent-child relationship applies to specific relationship between the permitter and the target. In this case, when the authentication for the child (the target) is successful and the permitter relating to the target is specified, the parent (the permitter) would pay the expense of the payment processing. Alternatively, the relationship between an apartment resident and a housekeeper also applies. When the authentication for the housekeeper (the target) is successful and the permitter relating to the target is specified, the apartment resident (the permitter) who is the employer would pay the expense of the payment processing. The permitter may set an upper limit for the payment processing. In this case, the target whose authentication is successful is not able to execute the payment processing that exceeds the upper limit. Further, the permitter may also limit the use application of the payment processing. For example, the permitter could be set so that only expense for purchase by the target at a particular store would be paid.

### (Flow of Operation)

Next, referring to FIG. 15, a flow of operation by the information processing system 10 according to the ninth example embodiment will be described. FIG. 15 is a flowchart showing the flow of the operation by the information processing system according to the ninth example embodiment. In FIG. 15, the reference signs same as in FIG. 7 are given to the processes similar to in FIG. 7 respectively.

As shown in FIG. 15, when the information processing system 10 according to the ninth example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case that both of them are successful (step S201: YES), the execution unit 140 permits the payment processing to the target (step S901). On the other hand, in a case that both of them are not successful (step S201: NO), the subsequent processes are omitted and a series of operation ends. That is, if either the authentication processing using the first living body information or the authentication processing using the second living body information is failed, the payment processing is not permitted to the target.

When the payment processing is permitted to the target, the execution unit 140 determines whether or not the payment processing is executed by the target (step S902). Then, in a case that the payment processing is executed by the target (step S902: YES), the expense therefor is paid by the payment method linked with the permitter (step S903). On the other hand, in a case that the payment processing is not executed by the target (step S902: NO), the subsequent processes are omitted, so that a series of operations ends.

### (Technical Effects)

Next, technical effects obtained by the information processing system 10 according to the ninth example embodiment will be described.

As described in FIG. 15, in the information processing system 10 according to the ninth example embodiment, when the authentication processing on the target is successful, the processing of permitting the payment processing to the target is executed, and the expense therefor is paid by the payment method linked with the permitter different from the target. By this way, it is possible to improve the target's convenience while enhancing security by biometric authentication.

### Tenth Example Embodiment

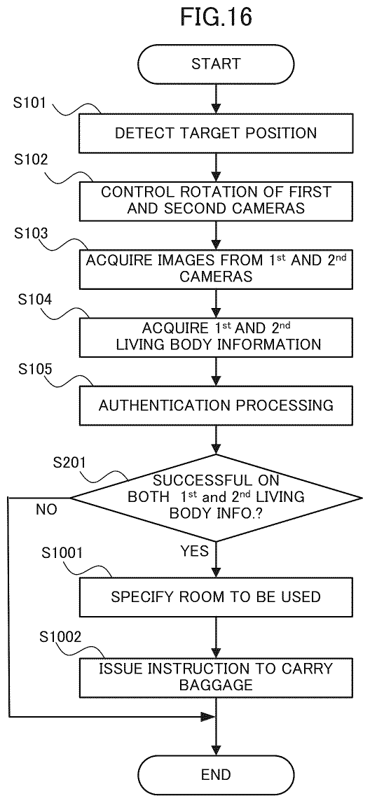

The information processing system 10 according to a tenth example embodiment will be described with reference to FIG. 16. The tenth example embodiment differs from the above-described first to ninth example embodiments in a part of the configuration and operation, and the other parts may be the same as those of the first to ninth example embodiments. Therefore, the part that differs from the example embodiments described above will be described in detail below, and the other overlapping parts will not be described as appropriate.

### (Contents of Predetermined Processing)

First, the contents of a predetermined processing executed in the information processing system 10 according to the tenth example embodiment will be described.

In the information processing system 10 according to the tenth example embodiment, the execution unit 140 executes processing of specifying a room to be used by the target as the predetermined processing. For example, if the target is a resident of an apartment building, then the execution unit 140 may specify a room number that is the home of the target. Information for specifying the room to be used by the target may be registered in advance or may be inputted by the target. Alternatively, by authenticating the target the room number of the home where the target resides may be acquired automatically. The execution unit 140 further executes, as the predetermined processing, processing of issuing an instruction to carry baggage of the target to the room specified. For example, like the example mentioned above, in the case that the room number in the apartment building which is the home of the target is specified, the execution unit 140 may output an instruction to carry the baggage of the target from the entrance to the room which is his/her home. The instruction to carry baggage may be outputted to, for example, a transport robot or the like, and/or may be outputted to staff or the like of the facility. Prior to outputting the instructions to carry baggage, the execution unit 140 may execute, to the target, processing of checking on the presence or absence, the number of pieces, the weight, and the like with respect to the baggage. In this case, the instruction to carry baggage may be outputted in consideration of the checked items. For example, in a case of many pieces of baggage or very heavy baggage, the instruction including such a precaution “a cart is required” may be outputted.

### (Flow of Operation)

Next, referring to FIG. 16, a flow of operation by the information processing system 10 according to the tenth example embodiment will be described. FIG. 16 is a flowchart showing the flow of the operation by the information processing system according to the tenth example embodiment. In FIG. 16, the reference signs same as in FIG. 7 are given to the processes similar to in FIG. 7 respectively.

As shown in FIG. 16, when the information processing system 10 according to the tenth example embodiment is operated, first, the rotation control unit 110 detects the position of the target (step S101). Then, the rotation control unit 110, depending on the target position detected, controls the rotation of the first camera 18 and the second camera 19 (step S102).

Subsequently, the living-body information acquisition unit 120 acquires the images (i.e. the first image and the second image) taken by the first camera 18 and the second camera 19 (step S103). Then, the living-body information acquisition unit 120 acquires the first image information from the first image taken by the first camera 18, and acquires the second image information from the second image taken by the second camera 19 (step S104).

Subsequently, the authentication unit 130 performs the authentication processing using the first living body information and the second living body information which have been acquired by the living-body information acquisition unit 120 (step S105). Then, the execution unit 140 determines whether or not, in the authentication unit 130, both the authentication processing using the first living body information and the authentication processing using the second living body information are successful (step S201).

In a case both the authentication processing is successful (step S201: YES), the execution unit 140 specifies the room to be used by the target (step S1001). Then, the execution unit 140 further issues an instruction to carry the baggage to the room specified (step S1002). If the target does not have baggage, the processes of steps S1001 and S1002 may be omitted.

### (Technical Effects)

Next, technical effects obtained by the information processing system 10 according to the tenth example embodiment will be described.

As described in FIG. 16, in the information processing system 10 according to the tenth example embodiment, when the authentication processing on the target is successful, the room to be used by the target is specified and the instruction to carry the target's baggage to the room specified. By this way, the convenience can be improved because the target does not have to carry the baggage by himself/herself. In addition, if the target is authenticated so that the room number of the target is specified automatically, it is possible to enhance the convenience more, compared to a case that the room number is inputted manually.

### Eleventh Example Embodiment

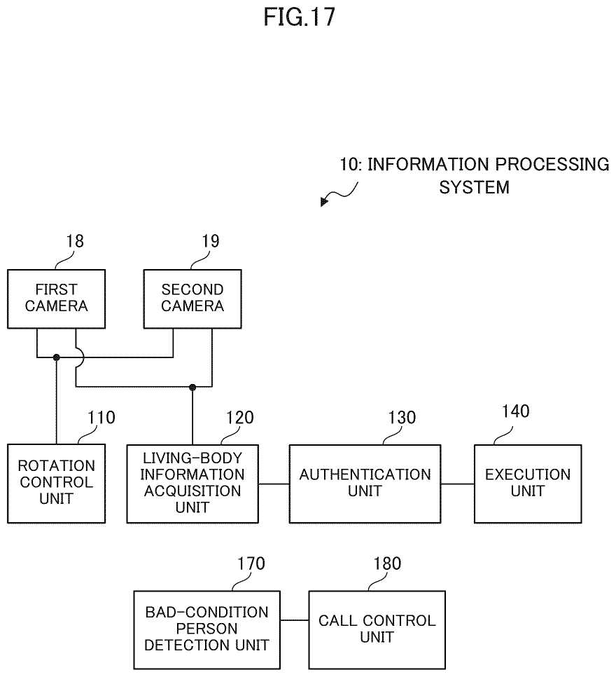

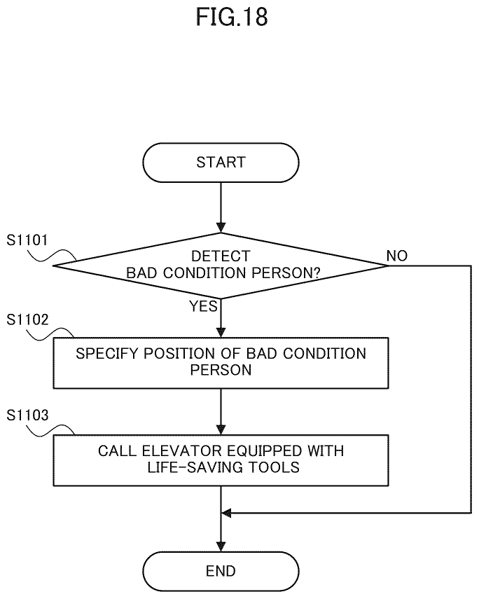

The information processing system 10 according to an eleventh example embodiment will be described with reference to FIGS. 17 and 18. The eleventh example embodiment differs from the above-described first to tenth example embodiments in a part of the configuration and operation, and the other parts may be the same as those of the first to tenth example embodiments. Therefore, the part that differs from the example embodiments described above will be described in detail below, and the other overlapping parts will not be described as appropriate.

### (Functional Configuration)

First, a functional configuration of the information processing system 10 according to the eleventh example embodiment will be described with reference to FIG. 17. FIG. 17 is a block diagram showing the functional configuration of the information processing system according to the eleventh example embodiment. In FIG. 17, the reference signs same as in FIG. 4 are given to the components similar to in FIG. 4 respectively.

As shown in FIG. 17, the information processing system 10 according to the eleventh example embodiment is configured by comprising, as components for realizing functions thereof, the first camera 18, the second camera 19, the rotation control unit 110, the living-body information acquisition unit 120, the authentication unit 130, the execution unit 140, a bad-condition person detection unit 170, and a call control unit 180. That is, the information processing system 10 according to the eleventh example embodiment is configured by further comprising the bad-condition person detection unit 170 and the call control unit 180 in addition to the components of the first example embodiment (c.f. FIG. 4). The bad-condition person detection unit 170 and the call control unit 180 may be each, for example, a processing block executed by the processor 11 described above (c.f. FIG. 1).

The bad-condition person detection unit 170 is configured so as to detect a user having bad condition in the facility (hereinafter, appropriately referred to as the “bad condition person”). The bad-condition person detection unit 170 may be configured so as to detect the bad condition person by, for example, using images of a monitoring camera or the like which is installed in the facility. Further, the bad-condition person detection unit 170 may be configured so as to detect the bad condition person by using images taken by an authentication terminal (e.g. the first camera 18 and the second camera 19) provided to the information processing system 10 according to the present example embodiment. In this case, the bad-condition person detection unit 170 may detect as the bad condition person, for example, a user falling down on the floor or a user sitting down. Further, the bad-condition person detection unit 170 may be configured so as to specify a place where the bad condition person exists. The bad-condition person detection unit 170 is configured to output to the call control unit 180, information relating to the bad condition person detected by the bad-condition person detection unit 170.

The call control unit 180 is configured so as to call an elevator equipped with life-saving tools to the floor corresponding to the position of the bad condition person detected by the bad-condition person detection unit 170. For example, in a case that the bad condition person falls down on the second floor, the call control unit 180 may execute processing of calling the elevator to the second floor (i.e. the floor where the bad condition person exists). However, if it is impossible to call the elevator to the floor where the bad condition person exists (for example, the elevator is not available for all floors), processing of calling the elevator to the floor closest to the target may be executed. The life-saving tools prepared in the elevator may include, for example, AED (Automated External Defibrillator), drinking drug, wound drug, adhesive tapes, bandage, and the like. After the elevator is called, alerts may be issued to the floor where the elevator has been called, residents of the floor where the elevator has been called, the concierge of the apartment building, security guards, and the like. In this case, there may be issued an instruction to manage with the life-saving tools prepared in the elevator.

### (Flow of Operation)

Next, referring to FIG. 18, a flow of operation by the information processing system 10 according to the eleventh example embodiment will be described. FIG. 18 is a flowchart showing the flow of the operation by the information processing system according to the eleventh example embodiment. The processing shown in FIG. 18 may be executed independently from a series of operations described with, for example, FIG. 7 etc (namely, operation of executing the biometric authentication and executing the predetermined processing based on the result thereof).

As shown in FIG. 18, when the information processing system 10 according to the eleventh example embodiment operates, first, the bad-condition person detection unit 170 detects the bad condition person in the facility (step S1101). In a case that the bad condition person is not detected (step S1101: NO), the subsequent processes are omitted, so that a series of operations ends.

On the other hand, when the bad condition person is detected (step S1101: YES), the bad-condition person detection unit 170 specifies the position of the bad condition person (step S1102). Then, the call control unit 180 calls the elevator equipped with the life-saving tools to the floor corresponding to the position of the bad condition person (step S1103). The call control unit 180 may give notice that the elevator equipped with the life-saving tool has been called, to the target himself/herself, a user who will rescue the target, and the like.

### (Technical Effects)

Next, technical effects obtained by the information processing system 10 according to the eleventh example embodiment will be described.

As described in FIGS. 17 and 18, in the information processing system 10 according to the eleventh example embodiment, when the bad condition person is detected in the facility, the elevator equipped with the life-saving tools is called to the floor corresponding to the position of the bad condition person. By this way, it is possible to appropriately and promptly rescue the bad condition person.

### Twelfth Example Embodiment

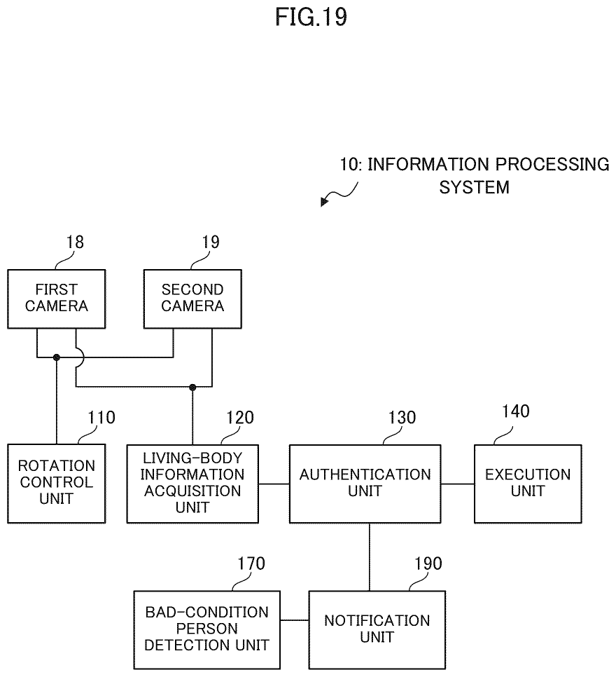

The information processing system 10 according to a twelfth example embodiment will be described with reference to FIGS. 19 to 21. The twelfth example embodiment differs from the above-described first to eleventh example embodiments in a part of the configuration and operation, and the other parts may be the same as those of the first to eleventh example embodiments. Therefore, the part that differs from the example embodiments described above will be described in detail below, and the other overlapping parts will not be described as appropriate.

### (Functional Configuration)

First, a functional configuration of the information processing system 10 according to the twelfth example embodiment will be described with reference to FIG. 19. FIG. 19 is a block diagram showing the functional configuration of the information processing system according to the twelfth example embodiment. In FIG. 19, the reference signs same as in FIGS. 4 and 17 are given to the components similar to in FIGS. 4 and 17 respectively.

As shown in FIG. 19, the information processing system 10 according to the twelfth example embodiment is configured by comprising, as components for realizing functions thereof, the first camera 18, the second camera 19, the rotation control unit 110, the living-body information acquisition unit 120, the authentication unit 130, the execution unit 140, the bad-condition person detection unit 170, and a notification unit 190. That is, the information processing system according to the twelfth example embodiment is configured by further comprising the bad-condition person detection unit 170 and the notification unit 190 in addition to the components of the first example embodiment (c.f. FIG. 4). The bad-condition person detection unit 170 may be the same as in the eleventh example embodiment already described. The notification unit 190 may be, for example, a processing block executed by the processor 11 described above (c.f. FIG. 1).

The notification unit 190 gives notice to a user linked with the target in a case that the bad condition person detected by the bad-condition person detection unit 170 is the target whose authentication processing is a successful. The notification unit 190 may give notice of information indicating the position where the target is down to, for example, the family of the target. The notification unit 190 may give notice using equipment in the facility (e.g. a display or a speaker installed in the facility, etc.). Alternatively, the notification unit 190 may give notice to a terminal (e.g. a smartphone) owned by the user linked with the target.

### (Flow of Operation)

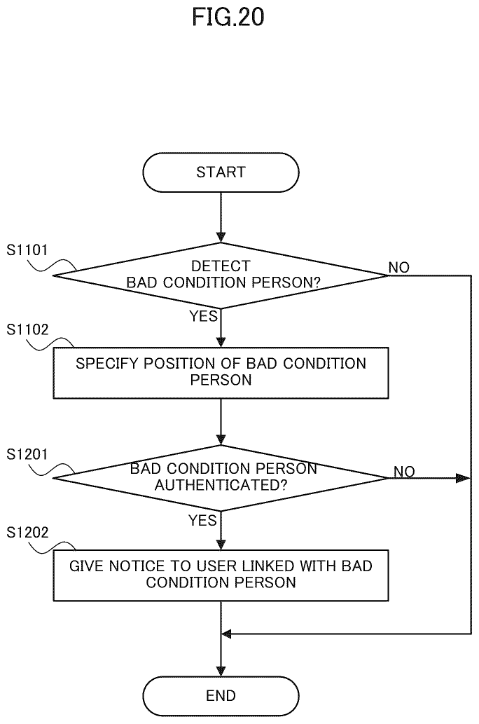

Next, referring to FIG. 20, a flow of operation by the information processing system 10 according to the twelfth example embodiment will be described. FIG. 20 is a flowchart showing the flow of the operation by the information processing system according to the twelfth example embodiment. In FIG. 20, the reference signs same as in FIG. 18 are given to the processes similar to in FIG. 18 respectively.

As shown in FIG. 20, when the information processing system 10 according to the twelfth example embodiment operates, first, the bad-condition person detection unit 170 detects the bad condition person in the facility (step S1101). In a case that the bad condition person is not detected (step S1101: NO), the subsequent processes are omitted, so that a series of operations ends.

On the other hand, when the bad condition person is detected (step S1101: YES), the bad-condition person detection unit 170 specifies the position of the bad condition person (step S1102). Then, the notification unit 190 determines whether the bad condition person has been already authenticated (i.e. whether the authentication processing using the first living body information and the second living body information is successful) (step S1201).

In a case that the bad condition person has been already authenticated (Step S1201: YES), the notification unit 190 gives notice to the user linked with the bad condition person (Step S1202). On the other hand, if the bad condition person has not been authenticated (step S1201: NO), the following processes are omitted and a series of the operations ends.

### (Modification)

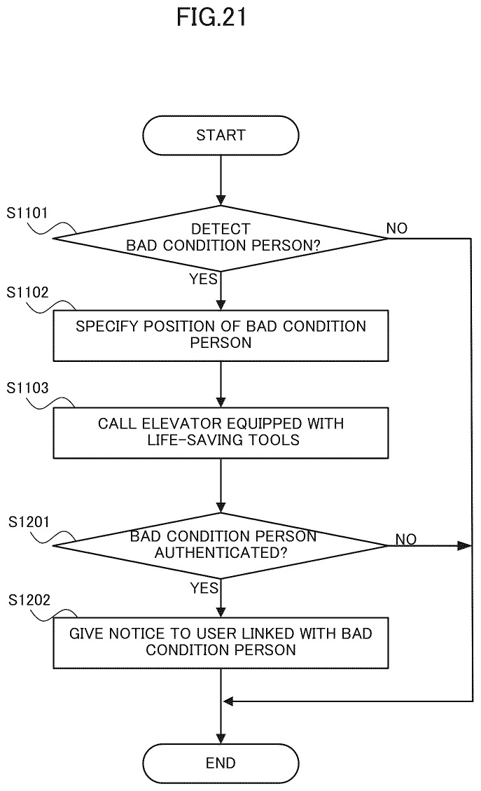

Next, a modification of the flow of the operation by the information processing system 10 according to the twelfth example embodiment will be described with reference to FIG. 21. FIG. 21 is a flowchart showing the modification of the flow of the operation by the information processing system according to the twelfth example embodiment. In FIG. 21, the reference signs same as in FIGS. 18 and 20 are given to the processes similar to in FIGS. 18 and 20 respectively.

As shown in FIG. 21, in the modification of the information processing system 10 according to the twelfth example embodiment, first, the bad-condition person detection unit 170 detects the bad condition person in the facility (step S1101). In a case that the bad condition person is not detected (step S1101: NO), the subsequent processes are omitted, so that a series of operations ends.

On the other hand, when the bad condition person is detected (step S1101: YES), the bad-condition person detection unit 170 specifies the position of the bad condition person (step S1102). In particular, the information processing system 10 according to the modification comprises the call control unit 180 (c.f. FIG. 17) described in the above-described eleventh example embodiment; the information processing system 10 calls the elevator equipped with the life-saving tools to the floor corresponding to the position of the bad condition person (step S1103).

Subsequently, the notification unit 190 determines whether or not the bad condition person has been already authenticated (step S1201). Then, in a case that the bad condition person has been already authenticated (Step S1201: YES), the notification unit 190 gives notice to the user linked with the bad condition person (Step S1202). On the other hand, if the bad condition person has not been authenticated (step S1201: NO), the following processes are omitted and a series of the operations ends.

### (Technical Effects)

Next, technical effects obtained by the information processing system 10 according to the twelfth example embodiment will be described.

As described in FIGS. 19 to 21, in the information processing system 10 according to the twelfth example embodiment, in a case that the bad condition parson has been already authenticated (in other words, the bad condition person has been specified as the target), the notice is given to the user linked with the target. By this way, it is possible to quickly inform the other user of the presence of the bad condition person; it is possible to appropriately perform the rescue and the like for the bad condition person.

### Thirteenth Example Embodiment

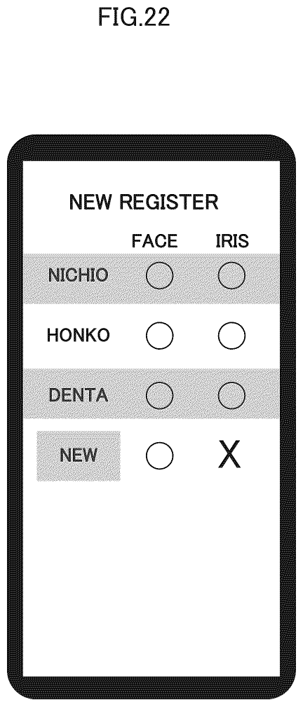

The information processing system 10 according to a thirteenth example embodiment will be described with reference to FIGS. 22 to 25. The thirteenth example embodiment is intended to show a specific operation example (a display example) with respect to the example embodiments from the first to the twelfth described above; with respect to the configuration and operation, and the like, the thirteenth example embodiment may be the same as the example embodiments from the first to twelfth. Therefore, the part that differs from the example embodiments described above will be described in detail below, and the other overlapping parts will not be described as appropriate.

### (Registration of Target)

First, referring to FIG. 22, a description will be given of a display example and operation when registering the target. FIG. 22 is a plan view showing an example of a display screen when registering the target. In the following, the description will proceed with the assumption that the first living body information is information relating to the face and the second living body information is information relating to the iris.

The registered user for the authentication processing may be added as appropriate. When the registered user is added, the face image may be taken to register the first living body information (the face information) and the iris image is taken to register the second living body information (the iris information). In addition, when it is difficult to take the iris image (for example, a case that a camera capable of taking the iris is not available), only the face image may be taken to first register the face information, and later the iris image may be taken to register the iris information.

As shown in FIG. 22, the registered user and the registration status thereof could be confirmed and edited, for example, on the smartphone. From FIG. 22, it can be confirmed that both the face information and the iris information are registered with respect to Nichio, Honko, and Denta. On the other hand, it can be confirmed that only the face information is registered and the iris information is not registered with respect to the user who is going to newly register. The names of these users may be editable as appropriate.

### (Update of Registered Information)

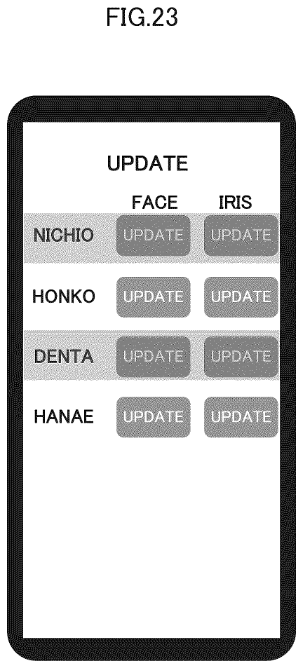

Next, with reference to FIG. 23, a description will be given of a display example and operation when updating registered information. FIG. 23 is a plan view showing an example of display screen when updating the registered information of target.

The face information registered and the iris information registered may be each updated to a new one. For example, since the face of an infant changes considerably in a certain period of time, an alert prompting updating of the registered information may be issued after a predetermined period of time from when the face information is registered. Also, the age of the target may be memorized, and the update frequency may be changed depending on the age. For example, the higher the age is, the lower the update frequency may be.

As shown in FIG. 23, when the registered information is updated, for example, on an update screen displayed on the smartphone, an update button corresponding to the user to be updated may be pressed and an image for the update may be taken. The image may be taken by a camera incorporated in the smartphone or the like, or by a dedicated registration terminal or the like. When the update is performed at the registration terminal, information for specifying the user (e.g., the room number or the like in the case of an apartment building) may be inputted.

### (Operation Depending on In-Home Status)

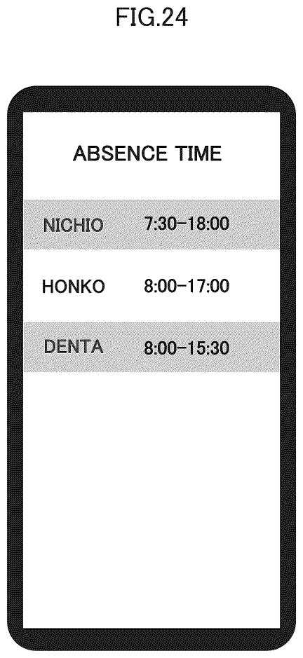

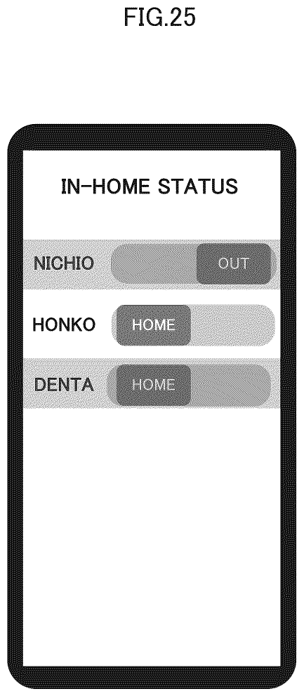

Next, with reference to FIGS. 24 and 25, a description will be given of operation example depending on in-home status. FIG. 24 is a plan view showing a display screen example showing absence time of the registered target. FIG. 25 is a plan view showing an display screen example showing in-home status of the registered target.

As shown in FIG. 24, the absence time of the registered user is inputted in advance. Then, in a case that there is a visitor in the absence time, notice may be sent to the terminal or the like of the registered user. In addition, in a case that impersonation has been detected, notice that the impersonation has been detected may be made.

As shown in FIG. 25, the in-home status may be changed based on the result of the authentication processing. For example, in a case that the authentication processing performed at the entrance of an apartment building is successful, the in-home status of the registered user may be changed to “HOME”. Further, in a case that the authentication processing performed at the moment of leaving an entrance of his/her home is successful, the status of the registered user may be changed to “OUT”.

### <The Other Predetermined Processing>

In the example embodiments described above, a plurality of examples have been given for the predetermined processing to be executed by the information processing system 10. However, the predetermined processing is not limited to those examples and may include the other processing.

For example, in a case that the authentication processing is performed at the moment of leaving the room, the predetermined processing may be processing of locking the room. Further, the predetermined processing may also be processing of giving notice that the target has left the room to a person involved in the target. Alternatively, in an apartment building providing concierge service, the predetermined processing may be processing of giving a concierge staff notice the target who left the room will stop at the concierge. Further, the predetermined processing may also be processing of asking the concierge to ship a package contained in the butler box installed in front of the room. In addition, the predetermined processing may be processing of when any package has arrived for the target, giving notice thereof to the target.

In addition, the predetermined processing may be processing relating with a shared facility in the facility (e.g. a fitness room, a bar lounge, a party room, a co-working space, or the like). For example, the predetermined processing may be processing of reserving the shared facility. In addition, the predetermined processing may be processing of allowing a user to pay for the cost of using the shared facility and the cost of purchasing within the shared facility by a payment method linked with the target. In addition, the predetermined processing may be processing of instructing a robot or the like to carry garbage (e.g. carry garbage up to a predetermined garbage disposal site)

Also included in the scope of each example embodiment is a processing method comprising the steps of: recording in a recording medium, a computer program to operate the configuration of each above-mentioned example embodiment so as to realize the functions of each example embodiment; reading out the computer program recorded in the recording medium as code; and executing the computer program in a computer. In other words, a computer-readable recording medium is also included in the scope of each example embodiment. In addition, not only the recording medium where the above-mentioned computer program is recorded but also the computer program itself is included in each embodiment.

For example, a floppy disk (registered trademark), a hard disk, an optical disk, an optical magnetic disk, a CD-ROM, a magnetic tape, a non-volatile memory cards and a ROM can be each used as the recording medium. In addition, not only the computer program recorded on the recording medium that executes processing by itself, but also the computer program that operates on an OS to execute processing in cooperation with other software and/or expansion board functions is included in the scope of each embodiment. Further, the computer program may be stored in a server so that a part or all of the computer program can be downloaded from the server to a user terminal.

The configurations and the flows of example embodiments described above are each possible to be combined with each other. In that case, three or more example embodiments may be combined.

### SUPPLEMENTARY NOTE

With respect to the example embodiments described above, they may be further described as the following supplementary notes, but are not limited to the following.

### (Supplementary Note 1)

An information processing system described in the supplementary note 1 is an information processing system comprising: a rotation control unit that makes a first camera and a second camera having a same rotation axis rotate on the rotation axis depending on a position of a target to be imaged; an acquisition unit that acquires a first living body information from an image taken by the first camera and acquires a second living body information from an image taken by the second camera; an authentication unit that executes authentication processing using the first living body information and the second living body information; and an execution unit that executes, in a case that the authentication processing is successful, predetermined processing in a facility that the target uses.

### (Supplementary Note 2)

An information processing system described in the supplementary note 2 is the information processing system according to the supplementary note 1, wherein the predetermined processing includes processing of permitting entry with respect to the facility, and the execution unit permits a first target and a second target different from the first target to enter the facility, on condition that on the first target the authentication processing using both the first living body information and the second living body information is successful, and also on the second target the authentication process using at least one of the first living body information and the second living body information is successful.

### (Supplementary Note 3)

An information processing system described in the supplementary note 3 is the information processing system according to the supplementary note 1 or 2, wherein the first camera and the second camera are configured so as to rotate on the rotation axis in response to operations of a user in the facility.

### (Supplementary Note 4)

An information processing system described in the supplementary note 4 is the information processing system according to any one of the supplementary notes 1 to 3, wherein the predetermined processing includes processing of calling an elevator to a floor where the target whose authentication processing is successful is located.

### (Supplementary Note 5)

An information processing system described in the supplementary note 5 is the information processing system according to any one of the supplementary notes 1 to 4, wherein the predetermined processing includes processing of calling to a predetermined position, a vehicle to be used by the target whose authentication processing is successful.

### (Supplementary Note 6)

An information processing system described in the supplementary note 6 is the information processing system according to any one of the supplementary notes 1 to 5, wherein the predetermined processing includes processing of guiding the target whose authentication processing is successful a route allowing the target to travel so as not to pass another person in the facility.

### (Supplementary Note 7)

An information processing system described in the supplementary note 7 is the information processing system according to any one of the supplementary notes 1 to 6, further comprising an alert unit that outputs an alert in a case that the target does not reach a predetermined position in a predetermined time after the authentication processing on the target has succeeded.

### (Supplementary Note 8)

An information processing system described in the supplementary note 8 is the information processing system according to any one of the supplementary notes 1 to 7, wherein the predetermined processing allows the target whose authentication processing is successful to request predetermined service, and sends to a request destination of the predetermined service, information indicating a position where the authentication processing has succeeded and information relating to the target, and expense for the predetermined service requested by the target is paid by a payment method linked with the target.

### (Supplementary Note 9)

An information processing system described in the supplementary note 9 is the information processing system according to any one of the supplementary notes 1 to 8, wherein the predetermined processing enables payment processing by the target whose authentication processing is successful, and expense for the payment processing by the target is paid by a payment method linked with a permitter permitting the target to execute the payment processing.

### (Supplementary Note 10)

An information processing system described in the supplementary note 10 is the information processing system according to any one of the supplementary notes 1 to 9, wherein the predetermined processing includes processing of specifying a room in the facility, the room being used by the target whose authentication processing is successful, and processing of issuing an instruction to carry baggage of the target to the room specified.

### (Supplementary Note 11)

An information processing system described in the supplementary note 11 is the information processing system according to any one of the supplementary notes 1 to 10, further comprising: a detection unit that detects a user being in bad condition in the facility; and a call control unit that calls an elevator equipped with life-saving tools to a floor corresponding to the user detected.

### (Supplementary Note 12)

An information processing system described in the supplementary note 12 is the information processing system according to any one of the supplementary notes 1 to 11, further comprising: a detection unit that detects a user being in bad condition in the facility; and a notification unit that gives notice to another user linked with the target, in a case that the user in bad condition is the target whose authentication processing is successful.

### (Supplementary Note 13)

An information processing apparatus described in the supplementary note 13 is an information processing apparatus comprising: a rotation control unit that makes a first camera and a second camera having a same rotation axis rotate on the rotation axis depending on a position of a target to be imaged; an acquisition unit that acquires a first living body information from an image taken by the first camera and acquires a second living body information from an image taken by the second camera; an authentication unit that executes authentication processing using the first living body information and the second living body information; and an execution unit that executes, in a case that the authentication processing is successful, predetermined processing in a facility that the target uses.

### (Supplementary Note 14)

An information processing method described in the supplementary note 14 is an information processing method executed by at least one computer, comprising: making first camera and a second camera having a same rotation axis rotate on the rotation axis depending on a position of a target to be imaged; acquiring a first living body information from an image taken by the first camera and acquiring a second living body information from an image taken by the second camera; executing authentication processing using the first living body information and the second living body information; and executing, in a case that the authentication processing is successful, predetermined processing in a facility that the target uses.

### (Supplementary Note 15)

A recording medium described in the supplementary note 15 is a recording medium storing a computer program that allows at least one computer to execute an information processing method, the information processing method comprising: making first camera and a second camera having a same rotation axis rotate on the rotation axis depending on a position of a target to be imaged; acquiring a first living body information from an image taken by the first camera and acquiring a second living body information from an image taken by the second camera; executing authentication processing using the first living body information and the second living body information; and executing, in a case that the authentication processing is successful, predetermined processing in a facility that the target uses.

### (Supplementary Note 16)

A computer program described in the supplementary note 16 is a computer program that allows at least one computer to execute an information processing method, the information processing method comprising: making first camera and a second camera having a same rotation axis rotate on the rotation axis depending on a position of a target to be imaged; acquiring a first living body information from an image taken by the first camera and acquiring a second living body information from an image taken by the second camera; executing authentication processing using the first living body information and the second living body information; and executing, in a case that the authentication processing is successful, predetermined processing in a facility that the target uses.

The disclosures can be modified as necessary to the extent that does not contradict the concept of idea of the invention that can be read from the entire claims and the entire description. Information processing systems, information processing apparatuses, information processing methods, and recording media with such modifications are also included in the technical concept of this disclosure.

### DESCRIPTION OF REFERENCE SIGNS

10 Information Processing System
11 Processor
18 First camera
19 Second camera
20 Motor
21 Near-Infrared Illuminator
30 Authentication Terminal
35 Camera Installation Portion
40 Display
50 Case
110 Rotation Control Unit
115 Target-Position Detection Unit
120 Living-Body Information Acquisition Unit
130 Authentication Unit
140 Execution Unit
150 Operation Accepting Unit
160 Alert Unit
170 Bad-Condition Person Detection Unit
180 Call Control Unit
190 Notification Unit

What is claimed is:

1. An information processing system comprising:
at least one memory configured to store instructions; and
at least one processor configured to execute the instructions to:
make a first camera and a second camera having a same rotation axis rotate on the rotation axis depending on a position of a target to be imaged;
acquire a first living body information from an image taken by the first camera and acquire a second living body information from an image taken by the second camera;
execute authentication processing using the first living body information and the second living body information; and
execute in a case that the authentication processing is successful, predetermined processing in a facility that the target uses.

2. The information processing system according to claim 1, wherein
the predetermined processing includes processing of permitting entry with respect to the facility, and
the at least one processor is configured to execute the instructions to
permit a first target and a second target different from the first target to enter the facility, on condition that on the first target the authentication processing using both the first living body information and the second living body information is successful, and also on the second target the authentication process using at least one of the first living body information and the second living body information is successful.

3. The information processing system according to claim 1, wherein
the first camera and the second camera are configured so as to rotate on the rotation axis in response to operations of a user in the facility.

4. The information processing system according to claim 1, wherein
the predetermined processing includes processing of calling an elevator to a floor where the target whose authentication processing is successful is located.

5. The information processing system according to claim 1, wherein
the predetermined processing includes processing of calling to a predetermined position, a vehicle to be used by the target whose authentication processing is successful.

6. The information processing system according to claim 1, wherein
the predetermined processing includes processing of guiding the target whose authentication processing is successful a route allowing the target to travel so as not to pass another person in the facility.

7. The information processing system according to claim 1, wherein
the at least one processor is further configured to execute the instructions to output an alert in a case that the target does not reach a predetermined position in a predetermined time after the authentication processing on the target has succeeded.

8. The information processing system according to claim 1, wherein
the at least one processor is configured to execute the instructions to
as the predetermined processing, allow the target whose authentication processing is successful to request predetermined service, and send to a request destination of the predetermined service, information indicating a position where the authentication processing has succeeded and information relating to the target, and
pay expense for the predetermined service requested by the target, by a payment method linked with the target.

9. The information processing system according to claim 1, wherein
the at least one processor is configured to execute the instructions to
as the predetermined processing, enable payment processing by the target whose authentication processing is successful, and
pay expense for the payment processing by the target, by a payment method linked with a permitter permitting the target to execute the payment processing.

10. The information processing system according to claim 1, wherein
the predetermined processing includes processing of specifying a room in the facility, the room being used by the target whose authentication processing is successful, and processing of issuing an instruction to carry baggage of the target to the room specified.

11. The information processing system according to claim 1, wherein
the at least one processor is further configured to execute the instructions to:
detect a user being in bad condition in the facility; and
call an elevator equipped with life-saving tools to a floor corresponding to the user detected.

12. The information processing system according to claim 1, wherein
the at least one processor is further configured to execute the instructions to:
detect a user being in bad condition in the facility; and
give notice to another user linked with the target, in a case that the user in bad condition is the target whose authentication processing is successful.

13. (canceled)

14. An information processing method executed by at least one computer, comprising:
making first camera and a second camera having a same rotation axis rotate on the rotation axis depending on a position of a target to be imaged;
acquiring a first living body information from an image taken by the first camera and acquiring a second living body information from an image taken by the second camera;
executing authentication processing using the first living body information and the second living body information; and
executing, in a case that the authentication processing is successful, predetermined processing in a facility that the target uses.

15. A non-transitory recording medium storing a computer program that allows at least one computer to execute an information processing method, the information processing method comprising:
making first camera and a second camera having a same rotation axis rotate on the rotation axis depending on a position of a target to be imaged;
acquiring a first living body information from an image taken by the first camera and acquiring a second living body information from an image taken by the second camera;
executing authentication processing using the first living body information and the second living body information; and
executing, in a case that the authentication processing is successful, predetermined processing in a facility that the target uses.
